(19) United States
(12) Patent Application Publication
(10) Pub. No.: US 2010/0129718 A1
(43) Pub. Date: May 27, 2010

(54) NEGATIVE ELECTRODE FOR LITHIUM SECONDARY BATTERY, LITHIUM SECONDARY BATTERY COMPRISING THE SAME, AND METHOD FOR PRODUCING NEGATIVE ELECTRODE FOR LITHIUM SECONDARY BATTERY

(76) Inventors: Hiroshi Higuchi, kyoto (JP); Tsunenori Yoshida, kyoto (JP)

Correspondence Address: MCDERMOTT WILL & EMERY LLP, 600 13TH STREET, NW, WASHINGTON, DC, 20005-3096, US

(21) Appl. No.: 12/595,188

(22) PCT Filed: Feb. 13, 2009
(86) PCT No.: PCT/JP2009/000573

§ 371 Date: Oct. 8, 2009

(30) Foreign Application Priority Data
Feb. 14, 2008 (JP) 2006-033081

(51) Int. Cl. H01M 4/58; B05D 5/12

(52) U.S. Cl. 429/231.95; 427/123

(57) ABSTRACT

A current collector 1 and a plurality of active material complexes 10 disposed on the current collector 1 and extending in a protruding direction from current collector 1 are included. Each active material complex 10 includes an active material member 2 made of a substance which occludes and releases lithium, and a conductor 4 disposed in contact with the active material member 2, the conductor 4 being made of a substance which does not occlude or release lithium. The conductor 4 extends in a direction non-parallel to the surface of the current collector 1 from the surface or surface vicinity of the current collector 1.

### TECHNICAL FIELD

The present invention relates to a negative electrode for a lithium secondary battery and a lithium secondary battery having the same, as well as a method of producing a negative electrode for a lithium secondary battery.

### BACKGROUND ART

The demand for small-sized electronic/electric devices such as portable communications devices is on the increase in recent years, and thus there is an increasing production of secondary batteries used therefor. Among others, there is a significant increase in the production of lithium secondary batteries, which have a high energy density.

As small-sized electronic/electric devices become more diversified in usage and smaller in size, further improvements in performance are required of lithium secondary batteries. Specifically, an increased discharge capacity and a prolonged life are needed more and more.

In lithium secondary batteries which are currently available on the market, a lithium-containing complex oxide such as LiCoO₂ is used for the positive electrode, and graphite is used for the negative electrode. However, a negative electrode material of graphite can absorb lithium ions only up to the composition of LiC₆, and the maximum value of its lithium ion-absorbing/releasing capacity per volume is 372 mAh/g. This value is only about ⅕ of the theoretical capacity of a metal lithium.

On the other hand, metallic elements such as Al, Ga, In, Si, Ge, Sn, Pb, As, Sb, and Bi and alloys thereof are known as elements which are capable of reversibly occluding and releasing lithium ions. The theoretical capacities per volume of these elements (e.g., Si: 2377 mAh/cm³, Ge: 2344 mAh/cm³, Sn: 1982 mAh/cm³, Al: 2167 mAh/cm³, Sb: 1679 mAh/cm³, Bi: 1768 mAh/cm³, Pb: 1720 mAh/cm³) are all greater than the capacity per volume of a carbonaceous material such as graphite.

However, a negative-electrode active material in which the aforementioned metallic elements are used will undergo significant expansion and contraction by occluding and releasing lithium ions at the time of charging and discharging. Therefore, in a negative electrode of a structure in which an active material layer containing a negative-electrode active material as mentioned above is formed on a sheet-like current collector, when charging and discharging are repeated, there is a possibility that a large stress may occur near the interface between the active material layer and the current collector to cause strain, thus resulting in wrinkles and cuts of the negative electrode, peeling of the active material layer, and so on. Thus, there is a problem in that the electrical connection between the active material layer and the current collector cannot be maintained, thus resulting in a reduced capacity.

Against this problem, Patent Document 1 discloses a method of suppressing peeling of the active material by alternately stacking active material layers and metal layers on the current collector. In this method, the metal layers not only suppress peeling of the active material, but also serve to maintain electrical contact between the active material layers and the current collector when destruction of the active material occurs. However, the metal layers are formed by painting a paste material, and the adhesion between the active material layers and the metal layers is not sufficient. Moreover, in an active material layer of Patent Document 1, no extra space to account for the expansion of the active material is formed as in Patent Documents 3 and 4, which will be mentioned later, and thus it is difficult to sufficiently suppress peeling of the active material layers caused by an expansion stress.

Moreover, Patent Document 2 discloses a method which allows an active material to fill inside the pores of a rigid porous ceramic powder, thereby suppressing volumetric changes due to lithium occlusion and suppressing dropping of the active material. The attempt made in this document is to mechanically suppress expansion of the active material by using a ceramic. However, the strength of a ceramic is not large enough to suppress the expansion of the active material, and there is a possibility of not sufficiently suppressing the dropping of the active material due to expansion.

On the other hand, Patent Documents 3 and 4 by the Applicant propose a construction in which a plurality of active material members are disposed at an interval on the surface of a sheet-like current collector, thus providing spaces with which to alleviate the expansion stress of a negative-electrode active material.

Patent Document 3 discloses roughening the surface of the sheet-like current collector in advance and vapor-depositing a negative-electrode active material onto the sheet-like current collector from an oblique direction, thus forming a plurality of pillar-like active material members on the current collector surface (oblique vapor deposition). At this time, predetermined spaces can be formed between adjoining active material members due to the masking effect (also called a shadowing effect) of the ruggednesses which are provided on the surface of the sheet-like current collector in advance. Patent Document 4 proposes, in order to more effectively alleviate the expansion stress of the active material that acts on the current collector, performing a plurality of steps of oblique vapor deposition while switching the evaporation direction, thereby forming active material members which are grown in a zigzag manner on the current collector.

Furthermore, Patent Document 5 proposes forming metal layers on the upper faces of a plurality of active material members, thus suppressing expansion in upper portions of the active material members and securing interspaces between adjoining active material members.

Thus, with the constructions disclosed in Patent Documents 3 to 5, expansion stress of the active material can be alleviated with spaces which are formed between adjoining active material members. Therefore, peeling of the active material members from the current collector surface is suppressed, so that lowering of the charge-discharge capacity due to peeling of the active material members can be suppressed.

[Patent Document 1] Japanese Patent No. 3750117

[Patent Document 2] Japanese Laid-Open Patent Publication No. 2000-90922

[Patent Document 3] Pamphlet of International Publication No. 2007/015419

[Patent Document 4] Pamphlet of International Publication No. 2007-052803

[Patent Document 5] Japanese Laid-Open Patent Publication No. 2006-278104

### DISCLOSURE OF INVENTION

### Problems to be Solved by the Invention

According to a study by the inventors, in the constructions of Patent Documents 3 to 5, each active material member extends in a pillar shape in a protruding direction from the current collector surface. Therefore, lithium ions have a greater moving speed in portions of the active material members that are close to the current collector surface than in portions which are far from the current collector surface. Thus, there is a problem in that charging and discharging occur with a higher priority in the portions which are close to the current collector surface, thus making crack failures likely to occur. Once a crack failure occurs in an active material member, electrical connection between the active material member and the current collector cannot be ensured, so that a cycle deterioration may occur.

The present invention has been made in view of the above circumstances and an objective thereof is, in a negative electrode for a lithium secondary battery in which a plurality of active material members are disposed on a current collector, to reduce non-uniformity in the moving speed of lithium ions within each active material member, thus suppressing crack failures of the active material member and ensuring electrical connection with the current collector even when a crack failure occurs in the active material member, thereby improving the charge-discharge cycle characteristics of the lithium secondary battery.

### Means for Solving the Problems

A negative electrode for a lithium secondary battery according to the present invention comprises: a current collector; and a plurality of active material complexes disposed on the current collector and extending in a protruding direction from the current collector, wherein, each active material complex includes an active material member made of a substance which occludes and releases lithium and a conductor disposed in contact with the active material member, the conductor being made of a substance which does not occlude or release lithium; and from a surface or surface vicinity of the current collector, the conductor extends in a direction non-parallel to the surface of the current collector.

According to the present invention, an active material member of each active material complex is in contact with a conductor which extends in a direction non-parallel to the surface of the current collector from the surface or surface vicinity of the current collector. As a result, even if a crack failure occurs in an active material member, electrical connection can be ensured between the active material member and the current collector on the basis of the conductor which is in contact with that active material member. Thus, deteriorations in the charge-discharge cycle characteristics due to crack failures can be suppressed.

Moreover, the conductor in each active material complex serves as a backbone for maintaining the shape of that active material complex, whereby an effect of mechanically suppressing autodestruction of the active material member due to repetitive charging and discharging can also be obtained.

Furthermore, it is possible to suppress non-uniformity in the moving speed of lithium ions in the interior of the active material members and at interfaces between the active material members and an electrolyte solution. As a result, it is possible to suppress crack failures and peeling of an active material member due to a portion of the active material member in which lithium ions have a large moving speed undergoing greater expansion and contraction than do the other portions through repetitive charging and discharging, whereby improved charge-discharge cycle characteristics can be obtained.

### EFFECTS OF THE INVENTION

With a negative electrode for a lithium secondary battery according to the present invention, crack failures of active material members and their peeling from the current collector are suppressed, and also electrical connection with the current collector is ensured even when a crack failure occurs in an active material member, whereby the charge-discharge cycle characteristics of the lithium secondary battery can be improved.

Thus, a negative electrode for a lithium secondary battery having excellent cycle characteristics, a method of producing the same, and a lithium secondary battery in which the same is used can be provided.

### BRIEF DESCRIPTION OF DRAWINGS

FIG. 1 A schematic cross-sectional view of a negative electrode for a lithium secondary battery according to Embodiment 1 of the present invention.

FIG. 2 (a) is a schematic enlarged cross-sectional view showing one active material complex of the negative electrode of Embodiment 1, and (b) is a schematic enlarged cross-sectional view showing one active material member of a conventional negative electrode.

FIG. 3 A schematic cross-sectional view showing another construction of a negative electrode for a lithium secondary battery according to Embodiment 1 of the present invention.

FIGS. 4 (a) and (b) are schematic diagrams illustrating an exemplary construction of a vapor deposition apparatus used for the formation of the active material complexes of embodiments of the present invention, where (a) is a cross-sectional view for describing the steps of forming active material members, and (b) is a cross-sectional view for describing the steps of forming conductors.

FIG. 5 (a) is a diagram showing an exemplary cross-sectional SEM image of active material members of Embodiment 1, showing a state after the active material members are formed but before nickel is vapor-deposited. (b) is a diagram showing an exemplary cross-sectional SEM image of the active material complexes of Embodiment 1.

FIG. 6 A schematic cross-sectional view of a negative electrode for a lithium secondary battery according to Embodiment 2 of the present invention.

FIG. 7 A schematic cross-sectional view illustrating an exemplary coin-type lithium-ion secondary battery in which a negative electrode according to the present invention is used.

FIG. 8 A schematic cross-sectional view showing another construction of a negative electrode for a lithium secondary battery according to Embodiment 2 of the present invention.

FIG. 9 A schematic cross-sectional view showing still another construction of a negative electrode for a lithium secondary battery according to Embodiment 2 of the present invention.

FIG. 10 A schematic cross-sectional view showing still another construction of a negative electrode for a lithium secondary battery of Embodiment 2 according to the present invention.

FIG. 11 A schematic cross-sectional view showing a negative electrode of Comparative Example 1.

FIG. 12 A schematic cross-sectional view showing a negative electrode of Comparative Example 2.

FIG. 13 A graph showing evaluation results of charge-discharge cycle characteristics of sample cells of Examples 1-1 to 1-3 and Comparative Example 1, where the horizontal axis represents the number of charging and discharging cycles and the vertical axis represents the capacity retention rate.

FIG. 14 A graph showing evaluation results of charge-discharge cycle characteristics of sample cells of Example 2 and Comparative Example 2, where the horizontal axis represents the number of charging and discharging cycles and the vertical axis represents the capacity retention rate.

FIG. 15 A schematic cross-sectional view showing a sputtering apparatus which is used for forming the conductors in Example 3.

FIG. 16 A diagram showing a cross-sectional SEM image of a sample negative electrode of Example 3.

FIG. 17 A graph showing evaluation results of charge-discharge cycle characteristics of sample cells of Example 3 and Comparative Example 3, where the horizontal axis represents the number of charging and discharging cycles and the vertical axis represents the capacity retention rate.

### DESCRIPTION OF REFERENCE NUMERALS

1 current collector
2 active material member
2a to 2e active material portion
4 conductor
4a to 4e conductive portion
10, 20 active material complex
22a portion of active material member that is located at or around farthest point from current collector or conductor
22b portion of active material member that is located at or around farthest point from current collector
100, 200, 400, 500, 600, 700 negative electrode
300 vapor deposition apparatus
30 chamber
31 silicon evaporation source
32 metal evaporation source
33 high-vacuum pump
34 low-vacuum pump
35 heater for current collector heating
36 rate monitor for silicon evaporation rate measurement
37 rate monitor for metal evaporation rate measurement
38 shutter
39 main valve
40 platform
45 horizontal plane
50 coin battery
51 positive electrode case
52 positive electrode
53 separator
54 negative electrode
55 gasket
56 sealing plate

### BEST MODE FOR CARRYING OUT THE INVENTION

### Embodiment 1

Hereinafter, with reference to the drawings, a first embodiment of a negative electrode for a lithium secondary battery according to the present invention (hereinafter simply referred to as a “negative electrode”) will be described.

First, FIG. 1 is referred to. FIG. 1 is a schematic cross-sectional view of a negative electrode for a lithium secondary battery of the present embodiment.

The negative electrode 100 includes a current collector 1 and a plurality of active material complexes 10 formed on the current collector 1. In the present embodiment, a plurality of bumps 13 are regularly arrayed on the surface of the current collector 1, such that each active material complex 10 is disposed on the corresponding bump 13. Each active material complex 10 extends in a protruding direction from the current collector 1, and includes an active material member 2 made of a substance which occludes and releases lithium, and a conductor 4 which is disposed in contact with the active material member 2. Herein, the active material member 2 contains silicon, tin, or an oxide such as silicon oxide or tin oxide as a substance which occludes and releases lithium. Moreover, the conductor 4 is made of a substance which does not occlude or release lithium, such that at least a part of the conductor 4 extends in a direction non-parallel to the surface of the current collector 1.

In the present embodiment, the active material member 2 has a growth direction S which is tilted with respect to the normal direction N of the current collector 1. In a cross section which is perpendicular to the current collector 1 and which contains the growth direction of the active material member 2, the conductor 4 is formed in a portion of the side face of the active material member 2 that is located on the upper side (hereinafter referred to as “an upper portion of the side face”) 3U. Moreover, a portion of the side face of the active material member 2 that is located on the lower side (hereinafter referred to as a “lower portion of the side face”) 3L is not covered with the conductor.

Note that, in the present specification, the normal direction N of the surface of the current collector 1 refers to a direction perpendicular to an imaginary plane which is obtained by averaging out the ruggednesses on the surface of the current collector 1. In the case where a plurality of bumps 13 are regularly formed on the surface of the current collector 1, as in the illustrated example, a plane that contains the uppermost faces or apices of these bumps is the surface of the current collector 1.

In the negative electrode 100 of the present embodiment, the active material member 2 of each active material complex 10 is in contact with a conductor 4 that extends from the surface vicinity of the current collector 1 in a direction non-parallel to the surface of the current collector 1. With such a construction, as will be specifically described later, it is possible to suppress a non-uniformity in the moving speed of lithium ions that occurs in the interior of the active material member 2 and at the interface between the active material member 2 and the electrolyte solution. Thus, it is possible to suppress crack failures and peeling of the active material member 2 due to a portion of the active material member 2 in which lithium ions have a large moving speed (in particular, the portion close to the current collector 1) undergoing a greater expansion and contraction than the other portions through repetitive charging and discharging. Even if the active material member 2 experiences a crack failure, electrical connection between the active material member 2 and the current collector 1 can be ensured on the basis of the conductor 4 which is in contact with the active material member 2. Furthermore, the conductor 4 of the present embodiment does not undergo expansion and contraction due to charging and discharging, because it extends generally along the growth direction S of the active material member 2 from the surface or surface vicinity of the current collector 1 and because it is made of a substance which does not occlude or release lithium. Therefore, it can also function as a backbone for maintaining the shape of the active material complex 10, and is able to suppress an autodestruction of the active material member 2 associated with repetitive charging and discharging.

The conductor 4 in the present embodiment extends from the surface or surface vicinity of the current collector 1. That is, the end of the conductor 4 at the current collector side is either in contact with the surface of the current collector 1 or located in the surface vicinity of the current collector 1. As used herein, the “surface vicinity” of the current collector 1 refers to a region which is sufficiently close to the surface of the current collector 1 and is able to possess a potential which is substantially equal to that of the current collector 1. With this construction, the potential of the conductor 4 can be made substantially equal to the potential of the current collector 1. Therefore, the potential differences in the interior of the active material member 2, i.e., non-uniformity in the moving speed of lithium ions, can be reduced.

As has been mentioned earlier, Patent Document 5 discloses forming a metal layer on the upper face of each active material member in order to suppress expansion in the upper portion of the active material member. In the construction disclosed in Patent Document 5, the metal layer is formed at a position away from the current collector surface, and thus does not provide an effect of ensuring electrical connection between the active material member and the current collector. Moreover, the metal layer is formed only on the upper face of the active material member so as to be substantially parallel to the current collector surface, such that any portion of the metal layer is substantially equidistant from the current collector surface. Such a metal layer cannot reduce potential differences within the interior of the active material member. Therefore, in the active material member disclosed in Patent Document 5, as in a conventional active material member in which no metal layer is formed, charging and discharging occur with a higher priority in a portion close to the surface of the current collector (portion with a high potential), so that cracks may occur in such a portion. Furthermore, the metal layer extends substantially parallel to the current collector surface, and cannot improve the strength of the active material member along the normal direction of the current collector. Therefore, it does not have a function of a backbone for maintaining the shape of the active material member.

On the other hand, according to the present embodiment, each conductive layer 4 extends from the surface or surface vicinity of the current collector 1 in a direction non-parallel to the surface of the current collector 1. As a result, the potential difference between the potential of a portion of the active material member 2 that is located near the current collector 1 and the potential of a portion that is more distant from the current collector 1 can be reduced. As a result, cracking of the active material member 2 due to the charging and discharging occurring with a higher priority in a portion of the active material member 2 located near the current collector 1 can be prevented. Moreover, the conductive layer 4 can ensure electrical connection between the active material member 2 and the current collector 1, and also enhance the mechanical strength of the active material member 2.

In the present embodiment, under conditions which enable charging and discharging, it is preferable that the area of contact between a conductor 4 and an active material member 2 is as large as possible, so that electrical connection can be ensured with a greater certainty even if the active material member 2 experiences autodestruction. For example, in the case where each active material member 2 has a pillar shape as shown in FIG. 1, there is an advantage if the conductor 4 extends on the side face of the active material member 2 along the growth direction S of the active material member 2 because a large area of contact is provided between the conductor 4 and the active material member 2. As used herein, “conditions which enable charging and discharging” mean conditions under which exchange of lithium ions between the active material member 2 and the electrolyte solution is possible and which allow charging and discharging to occur with a designed current.

Furthermore, it is preferable that each conductor 4 extends from the bottom face of an active material complex 10 to an upper face 3T of the active material complex 10. As a result, even if the active material member 2 experiences autodestruction, electrical connection between the active material member 2 and the current collector 1 can be ensured with a greater certainty, and the moving speed of lithium ions in the interior of the active material member 2 can be made more uniform. In the present specification, the “upper face” of the active material complex 10 refers to, within the surface of the active material complex 10, a face 3T that contains a portion whose distance from the surface of the current collector 1 along the normal direction of the current collector 1 is the longest.

In the negative electrode 100, each conductor 4 is formed in an upper portion of the side face 3U of the active material member 2, but may be formed on the lower side face 3L. However, in order not to prevent movement of lithium ions between the active material member 2 and the electrolyte solution, it is preferable that the conductor 4 is made of a porous conductive film and it does not cover the entire surface of the active material member 2. For example, as in the embodiments described later, the conductor 4 may be formed in the interior of the active material member 2.

Preferably, the current collector 1 of the present embodiment includes bumps 13 which are regularly arrayed on its surface. The reason is that, particularly in the case where the active material members 2 are formed on the surface of the current collector 1 by utilizing oblique vapor deposition, the layout of the active material members 2 and the size of the voids between active material members 2 can be controlled by appropriately adjusting the shape, size, arraying pitch, etc., of the bumps 13. Therefore, a space for expansion can be secured between adjoining active material members 2 with a greater certainty, and the expansion stress acting at the interfaces between the active material members 2 and the current collector 1 can be alleviated. The method for forming such bumps 13 will be described later. Note that, so long as the current collector includes a plurality of bumps on its surface, it is possible to use as the current collector 1 a metal foil on which bumps of various sizes and shapes are randomly provided, for example. In this case, too, the active material members 2 are formed on the bumps at an interval, so that voids can be obtained between adjoining active material members 2.

In the negative electrode 100, since the active material members 2 are formed by utilizing oblique vapor deposition, the active material members 2 have a growth direction S which is tilted with respect to the normal direction N of the current collector 1, and each active material complex 10 also has a shape which is tilted along the growth direction S of the active material member 2. Note that, when a lithium-ion battery is constructed by using the negative electrode 100, the active material member 2 of each active material complex 10 will occlude lithium ions and expand upon charging, and thus the tilting angle of the active material complex 10 with respect to the normal direction N of the current collector 1 may become so small that the active material complex 10 stands substantially upright. Even in this case, when the active material member 2 releases lithium ions upon discharging, the active material complex 10 will again be tilted.

As a material which occludes and releases lithium, the active material members 2 of the present embodiment contain an active material which is selected from the group consisting of silicon, tin, silicon oxide, tin oxide, and a mixture thereof. The active material members 2 may contain a compound that contains silicon, oxygen, and nitrogen, or may be made of a composite of a plurality of silicon oxides with different ratios between silicon and oxygen. Other than the aforementioned oxides, the active material members 2 may contain e.g. elemental silicon, a silicon alloy, a compound containing silicon and nitrogen, or the like. Furthermore, lithium or an impurity such as Fe, Al, Ca, Mn, or Ti may be contained in the active material members 2.

In the case where the active material member 2 contains silicon oxide, the active material member 2 may have a chemical composition represented as SiOx(x:0<x<2) as a whole, and may locally include portions where the oxygen concentration is 0% (e.g., SiOx(x=0)). An average value of the molar ratio x of the oxygen amount with respect to the silicon amount of each active material member 2 is preferably greater than 0 but no more than 0.6. When an average value of the aforementioned x is 0.6 or less, a high charge-discharge capacity can be ensured without increasing the thickness t of the active material layer 14.

Preferably, the height H of an active material member 2 is e.g. no less than 5 μm and no more than 100 μm, and more preferably, no less than 5 μm and no more than 50 μm. As used herein, “the height of an active material member 2” means the height of the active material member 2 from the upper face or apex of the bump 13 of the current collector 1, taken along the normal direction N of the current collector 1. When the height H of the active material members 2 is 5 μm or more, a sufficient energy density can be ensured. In particular, when silicon oxide is used as the negative-electrode active material, it is possible to take advantage of the high capacity characteristics of silicon oxide. If the height H of the active material member 2 exceeds 100 μm, not only will it become difficult to form the active material members 2, but also the aspect ratio of the active material members 2 will be large, so that breaking or the like of the active material members 2 will be likely to occur, causing deteriorations in characteristics.

The conductors 4 in the present embodiment are made of an electrically conductive substance which does not occlude and release lithium and which does not react with the electrolyte solution. The material of the conductors 4 may be, for example, a metal whose main component is at least one element selected from the group consisting of Cu, Ni, Ti, Zr, Cr, Fe, Mo, Mn, Nb, and V, or an electrically conductive ceramic whose main component is a nitride of Ti and/or a nitride of Zr.

Moreover, the thickness t of a conductor 4 is preferably no less than 0.05 μm and no more than 10 μm. As used herein, “the thickness of a conductor 4” means an average value of the thickness of the conductor 4 from the contact face between the active material member 2 and the conductor 4, taken along the normal direction of the contact face. When the thickness of the conductor 4 is 0.05 μm or more, deteriorations in characteristics due to non-uniformity in the moving speed of lithium ions or crack failures in the active material member 2 can be suppressed with a greater certainty. On the other hand, if the thickness t of the conductor 4 exceeds 10 μm, the volume proportion of the active material member 2 occupied in the active material complex 10 becomes small, thus leading to a possibility that a high capacity may not be realized.

Although there is no particular limitation, in order to prevent cracking of the active material complex 10 due to an expansion upon charging, it is preferable that the thickness (width) of an active material complex 10 is no more than 50 μm, and more preferably no less than 1 μm and no more than 20 μm. Note that the thickness of an active material complex 10 can be determined, among e.g. two to ten arbitrary active material complexes 10, as an average value of the width of a cross section which is parallel to the surface of the current collector 1 and taken along a ½ thickness (thickness along the normal direction N of the current collector) plane of the active material complex 10. If the aforementioned cross section is a substantially circular shape, it will be an average value of the diameter.

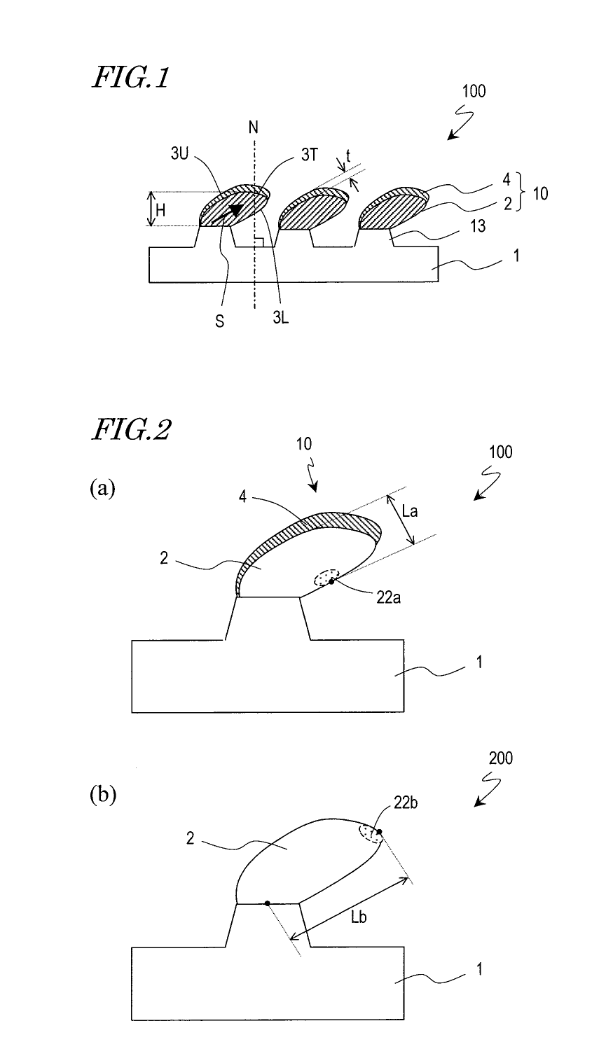

Now, with reference to the drawings, the reasons why the conductors 4 of the present embodiment reduce non-uniformity in the moving speed of lithium ions in the interior of the active material members 2 and at the interfaces between the active material members 2 and the electrolyte solution will be described. FIGS. 2(a) and (b) are schematic enlarged views showing, respectively, the negative electrode 100 of the present embodiment and a conventional negative electrode 200, where FIG. 2(a) is a cross-sectional view showing one active material complex according to the present embodiment. FIG. 2(b) is a cross-sectional view showing one active material member in the case where no conductors are formed. For simplicity, constituent elements which are similar to those in FIG. 1 will be denoted by like reference numerals, and the descriptions thereof will be omitted.

In the case where a lithium secondary battery is constructed by using the negative electrodes shown in FIGS. 2(a) and (b), these negative electrodes are disposed so as to oppose a positive electrode, and an electrolyte solution is filled between the negative electrode and the positive electrode. Therefore, although not shown, the surfaces of the active material complex 10 and the active material member 2 are in contact with the electrolyte solution.

The driving forces which cause lithium ions to move in the interior of the active material members 2 of the negative electrodes 100 and 200 are a Coulomb force which acts on lithium ions in accordance with the potential gradient between the electrolyte solution and the current collector 1, and diffusion due to thermal vibration. Among these, since the diffusion due to thermal vibration is determined by the operating temperatures of the negative electrodes 100 and 200, if their operating temperatures are equal, the moving speed of lithium ions will be determined based solely on the Coulomb force. Accordingly, by comparing the non-uniformities in the Coulomb force occurring in the interior of the active material members 2, it becomes possible to infer a non-uniformity in the moving speed of lithium ions.

First, the minimum values of a Coulomb force that acts on lithium ions which are present in an active material member 2 of the negative electrode 100 and the negative electrode 200 are as follows.

In the negative electrode 100 of the present embodiment shown in FIG. 2(a), the current collector 1 and the conductor 4 have a substantially equal potential, and therefore the portion of the active material member 2 where the Coulomb force is minimum is a portion 22a which is located the farthest from the current collector 1 or the conductor 4. Given that the potential of the current collector 1 and the conductor 4 is V₀; the potential of the portion 22a of the active material member 2 is Va; and the distance between the current collector 1 or the conductor 4 and the portion 22a of the active material member 2 is La, then the Coulomb force Faₘᵢₙ that acts on the lithium ions which are present in the portion 22a is:

Faₘᵢₙ=q(Va−V₀)/La.

In the conventional negative electrode 200 shown in FIG. 2(b), the Coulomb force is minimum at a portion 22b of the active material member 2 which is located the farthest from the current collector 1. Given that the potential of the current collector 1 is V₀; the potential of the portion 22b of the active material member 2 is Vb; the distance between the current collector 1 and the portion 22b of the active material member 2 is Lb; and an elementary charge is q, then the Coulomb force Fbₘᵢₙ that acts on the lithium ions which are present in the portion 22b is:

Fbₘᵢₙ=q(Vb−V₀)/Lb.

Herein, the potential Va of the portion 22a of the active material member 2 of the negative electrode 100 and the potential Vb of the portion 22b of the active material member 2 of the negative electrode 200 are substantially equal (Va≈Vb). The reason is that, considering the fact that the portions 22a and 22b are in contact with the same electrolyte solution and the lithium-ion conductivity of an electrolyte solution is substantially greater than the ion conductance of the active material member 2 by five digits or more, the voltage drop due to lithium-ion conduction within the electrolyte solution is considered to be negligibly small. Moreover, since the conductor 4 extending non-parallel to the surface of the current collector 1 is formed in the negative electrode 100, the distance La between the current collector 1 or the conductor 4 and the portion 22a of the active material member 2 is smaller than the distance Lb between the current collector 1 and the portion 22b of the active material member 2 in the negative electrode 200 (La<Lb).

Therefore, the minimum Coulomb force Faₘᵢₙ acting on the lithium ions which are present in the interior of the active material members 2 of the negative electrode 100 is greater than the minimum Coulomb force Fbₘᵢₙ acting on the lithium ions which are present in the interior of the active material members 2 of the negative electrode 200 (Faₘᵢₙ>Fbₘᵢₙ).

On the other hand, in both of the negative electrode 100 and the negative electrode 200, the Coulomb force that acts on the lithium ions which are present near the interface of the active material member 2 with the current collector 1 or the conductor 4 is largest. Therefore, between the negative electrodes 100 and 200, the distance between the portion of the active material member 2 where the Coulomb force is largest and the current collector 1 is equal (substantially zero), and thus the maximum values of Coulomb force (maximum Coulomb forces) Faₘₐₓ and Fbₘₐₓ are substantially equal (Faₘₐₓ=Fbₘₐₓ).

This indicates that, in the negative electrode 100 having the conductors 4, the difference between the maximum Coulomb force Faₘᵢₙ and the minimum Coulomb force Faₘₐₓ is small as compared to the conventional negative electrode 200, and thus its non-uniformity in Coulomb force is reduced ((Faₘₐₓ−Faₘᵢₙ)<(Fbₘₐₓ−Fbₘᵢₙ)). As described above, when the operating temperatures of the negative electrodes 100 and 200 are equal, the moving speeds of lithium ions are determined based solely on the Coulomb force, which indicates that provision of the conductors 4 reduces non-uniformity in the moving speed of lithium ions. Therefore, it is possible to suppress cracks occurring in the active material members 2 due to a portion of each active material member 2 (the portion where lithium ions have a large moving speed) undergoing a greater expansion and contraction than the other portions upon charging and discharging.

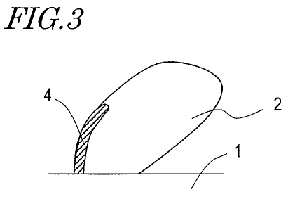

Note that the conductor 4 does not need to extend continuously from the bottom face to the upper face of each active material complex 10. For example, in the case where the conductor 4 is formed only in a part of an upper portion of the side face of the active material complex 10, as shown in FIG. 3, the distance L between and the current collector 1 or the conductor 4 and the portion of the active material member 2 that is located the farthest from the current collector 1 or the conductor 4 can be made shorter than conventionally, whereby the non-uniformity in the moving speed of lithium ions can be reduced. It also provides an effect of ensuring electrical connection between the active material member 2 and the current collector 1 when a crack failure occurs in the active material member 2.

### <Method of Producing Negative Electrode 100>

Next, an exemplary method of producing the negative electrode 100 of the present embodiment will be described.

First, by forming a ruggedness pattern on the surface of a metal foil, a sheet-like current collector 1 having a plurality of bumps 13 on its surface is produced.

As a metal foil, a copper foil whose surface is roughened may be used, for example. Other than copper as a main component, the copper foil may contain elements which do not react with lithium, e.g., zirconium and titanium, and elements which will inevitably be mixed, e.g., oxygen, selenium, and tellurium. Herein, a copper foil (manufactured by Furukawa Circuit Foil Co., Ltd.) having a thickness of 35 μm and a surface roughness Ra of 2.0 μm is used, for example. Note that “surface roughness Ra” refers to “arithmetic mean roughness Ra” as defined under the Japanese Industrial Standards (JISB 0601-1994), and can be measured by using a surface roughness measurement system, a confocal laser microscope, or the like.

The current collector 1 may be produced by forming a predetermined pattern of grooves on the surface of a metal foil by using a cutting technique, or by forming a plurality of bumps 13 on the surface of a metal foil by a plating technique or a transfer technique. Preferable ranges of the shape, height, arraying pitch, and the like of the bumps 13 will be described later. As the current collector 1, a metal foil (rugged foil) having a large surface roughness that is available on the market can also be used.

Next, on the surface of the current collector 1, silicon oxide (SiOx(0<x<2)) is grown by oblique vapor deposition, thus forming the active material members 2. Thereafter, nickel is deposited as a conductor 4 on each active material member 2 obtained. In the case where the active material members 2 are silicon, oxygen is not to be introduced into a vacuum container at the time of vapor deposition. By employing a tin evaporation source using tin instead of a silicon evaporation source 31 described below, tin oxide (0<x<2) or tin can be grown as the plurality of active material members 2 on the surface of the current collector 1. Hereinafter, a case will be described where silicon oxide is grown as the active material members 2.

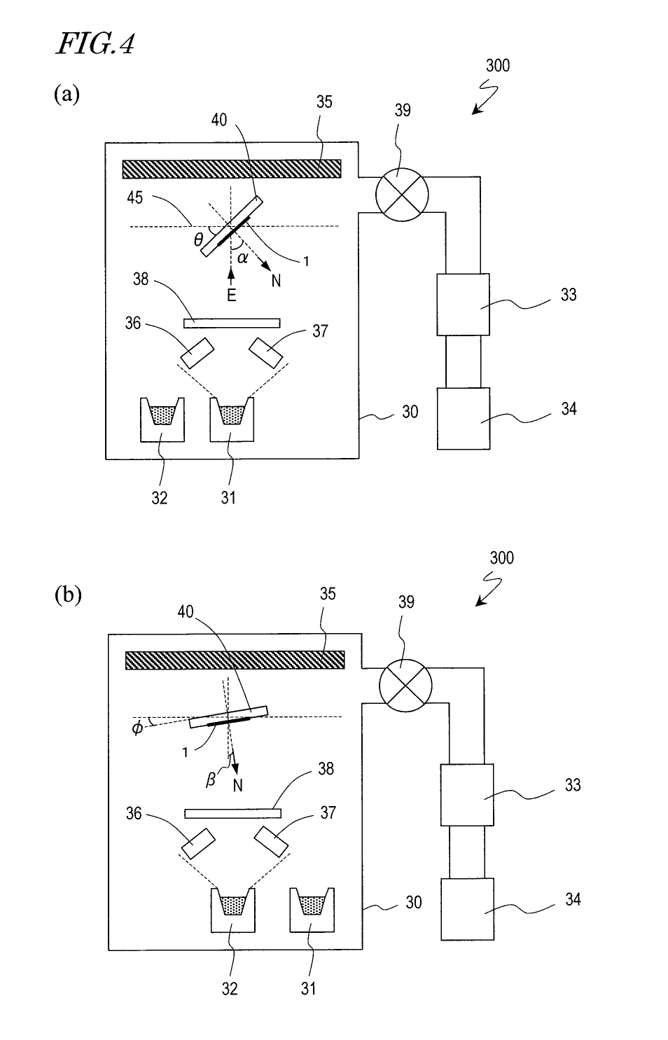

FIGS. 4(a) and (b) are diagrams illustrating an exemplary construction of a vapor deposition apparatus employed when forming the active material members 2 and the conductors 4.

A vapor deposition apparatus 300 includes a chamber 30 and a high-vacuum pump 33 and a low-vacuum pump 34 for evacuating the chamber 30. The pumps 33 and 34 are connected to the chamber 30 via a main valve 39. Preferably, the high-vacuum pump 33 attains a degree of vacuum of 10⁻⁴ Pa or less, and more preferably 10⁻⁶ Pa or less. The low-vacuum pump 34 may be any that is capable of maintaining a degree of vacuum which is equal to or less than the critical back pressure of the high-vacuum pump 33.

In the interior of the chamber 30, a platform 40 on which to fix the current collector 1, a silicon evaporation source 31 for supplying silicon onto the surface of the current collector 1 fixed on the platform 40, a metal evaporation source (which herein is a nickel evaporation source) 32 for supplying the material of the conductors 4 onto the surface of the current collector 1 fixed on the platform 40, and a heater 35 for heating the current collector, which is for heating the current collector 1 placed on the platform 40. Note that the silicon evaporation source 31 and the metal evaporation source (which herein is a nickel evaporation source) 32 are movable copper evaporation sources. While fixing the current collector 1 on the platform 40, the evaporation sources are placed under the platform 40 to perform vapor deposition. Therefore, when the silicon evaporation source 31 is placed under the platform 40, as shown in FIG. 4(a), silicon can be vapor-deposited on the surface of the current collector 1. When the metal evaporation source (nickel evaporation source) 32 is placed under the platform 40, as shown in FIG. 4(b), a metal (nickel) can be vapor-deposited.

The platform 40 has a rotation axis (not shown), and as the platform 40 is rotated around this rotation axis, the angles (tilting angles) θ and φ of the platform 40 with respect to the horizontal plane 45 can be adjusted. Herein, the “horizontal plane” refers to a plane which is perpendicular to the direction in which the materials of the silicon evaporation source 31 and the metal evaporation source 32 are vaporized and travel toward the platform 40. The silicon evaporation source 31 and the metal evaporation source 32 are copper crucibles of an electron beam gun heating type, for example. The electron beam gun may have an output power such that the acceleration voltage is about 5 to about 10 kV and the irradiation current is about 0.3 to about 1 A, and may be JEBG-303UA electron gun manufactured by JEOL Ltd., for example.

Between the platform 40 and the evaporation source used (the silicon evaporation source 31 or the metal evaporation source 32), a shutter 38 is disposed. Between the evaporation source used and the shutter 38, rate monitors 36 and 37 for controlling the evaporation rate are disposed. Herein, the rate monitor 36 is used when controlling the evaporation rate of silicon, whereas the rate monitor 37 is used when controlling the evaporation rate of the metal (nickel).

Although not shown, as necessary, an oxygen supply tube for introducing oxygen and an argon supply tube for introducing argon into the chamber 30 are provided. In the case where silicon oxide is to be grown on the current collector 1, oxygen is supplied through the oxygen supply tube onto the surface of the current collector 1 fixed on the platform 40. The oxygen flow rate can be controlled by using a mass flow controller or the like. Moreover, argon may be supplied to the chamber 30 in order to adjust the gas pressure in the chamber 30. For example, since the amount of silicon and the amount of nickel evaporating from the evaporation sources 31 and 32 will greatly change depending on the gas pressure in the chamber 30, a predetermined amount of argon may be introduced into the chamber 30 to maintain a constant gas pressure in a range from 10⁻⁴ Pa to 1×10⁻² Pa in the chamber 30. Note that, in the case where oxygen is supplied to the chamber 30, argon does not need to be introduced, and the gas pressure in the chamber 30 may be adjusted based only on the supply amount of oxygen.

A method of forming the active material members 2 by using the vapor deposition apparatus 300 will be specifically described.

First, as shown in FIG. 4(a), the silicon evaporation source 31 is placed under the platform 40. Moreover, the current collector 1 is placed on the platform 40 so that its face having the plurality of bumps 13 formed thereon is upward, and the platform 40 is rotated until fixed at a position where the tilting angle θ of the platform 40 with respect to the horizontal plane 45 is greater than 0° and less than 90° (e.g. θ=70°). Note that the incident direction E of silicon with respect to the normal direction N of the current collector 1 (i.e., evaporation direction) can be adjusted based on the tilting direction of the platform 40 from the horizontal plane 45. The absolute value of the tilting angle θ is equal to the angle (incident angle of silicon) a between the incident direction E of silicon with respect to the current collector 1 placed on the platform 40 and the normal direction N of the current collector 1. Therefore, by adjusting the tilting angle θ of the platform 40, the growth direction S of the active material members 2 to be grown on the surface of the current collector 1 can be controlled.

Next, in a state where the shutter 38 is shut, silicon is allowed to evaporate from the silicon evaporation source 31. When it is confirmed with the rate monitor 36 that the evaporation rate of the silicon striking the current collector 1 has reached a predetermined value, the shutter 38 is opened to allow silicon to strike the surface of the current collector 1 at the incident angle α (e.g. 60°). In the present embodiment, high-purity oxygen is supplied onto the surface of the current collector 1 together with silicon. As a result, through reactive evaporation, a compound (silicon oxide) containing silicon and oxygen can be grown on the surface of the current collector 1.

At this time, the silicon atoms emitted from the silicon evaporation source 31 strike the surface of the current collector 1 from the direction E, which is tilted with respect to the normal direction N of the current collector 1, and therefore are easy to be vapor-deposited on the bumps on the surface of the current collector 1, Thus, silicon oxide grows in pillar shapes on the bumps. As a result, on the surface of the current collector 1, regions are created which are shaded by the bumps and the silicon oxide growing in pillar shapes, such that silicon atoms do not strike these regions and silicon oxide is not vapor-deposited there (shadowing effect). In the illustrated example, because of this shadowing effect, regions exist on the grooves between adjoining bumps where no silicon atoms adhere and silicon oxide does not grow. As a result of this, a plurality of active material members can be formed on the surface of the current collector 1 at an interval (active material vapor deposition step).

Next, conductors are vapor-deposited on the current collector 1 having the active material members formed thereon. Hereinafter, an example will be described where the material of the conductors is nickel. If this material is titanium or copper, the same can be carried out by changing the below-described metal evaporation sources from a nickel evaporation source to a titanium evaporation source or a copper evaporation source.

Specifically, first, as shown in FIG. 4(b), while fixing the current collector 1 on the platform 40, the metal evaporation source (nickel evaporation source) 32 is placed under the platform 40. Moreover, the tilting angle φ of the platform 40 with respect to the horizontal plane 45 is adjusted. Herein, the platform 40b is fixed along the horizontal plane 45 (tilting angle φ=0°, and the incident angle β of nickel from the metal evaporation source 32 with respect to the normal direction N of the current collector 1 is substantially 0°.

Next, in a state where the shutter 38 is shut, nickel is allowed to evaporate from the metal evaporation source 32. When it is confirmed with the rate monitor 37 that the evaporation rate of the nickel striking the current collector 1 has reached a predetermined value, the shutter 38 is opened to allow nickel to strike the surface of the current collector 1 from the normal direction N of the current collector 1. As a result, nickel is deposited on portions of the surface of each active material member that oppose the metal evaporation source 32, i.e., an upper portion of the side face and the upper face of each active material members 2, whereby conductors made of nickel are obtained (conductors vapor deposition step). In this manner, active material complexes having active material members and conductors can be formed on the surface of the current collector 1.

In the aforementioned method, it is preferable that the incident angle α of silicon with respect to the normal direction N of the current collector 1 and the incident angle β of the metal which is the material of the conductors (e.g. nickel) are different from each other. The reason is that, if the incident angle α and the incident angle β are equal, nickel may be deposited only on the upper faces of the active material members, thus making it impossible to form conductors which extend non-parallel to the surface of the current collector 1.

Preferably, the absolute value of the incident angle β of nickel is smaller than the absolute value of the incident angle α of silicon (|β|<|α|). If the absolute value of the incident angle β of nickel is equal to or greater than the absolute value of the incident angle α of silicon, a greater shadowing effect will occur at the vapor deposition step of nickel than at the vapor deposition step of silicon. This leads to a possibility that nickel may be formed in pillar shapes on the surface of the active material members, thus resulting in a small area of contact between each active material member and the conductor, or a large distance between the current collector and the conductor. On the other hand, if the absolute value of the incident angle β of nickel is controlled to be smaller than the absolute value of the incident angle α of silicon, a sufficient area of contact can be secured between each active material member and the conductor.

The absolute value of the incident angle α of silicon is preferably no less than 20° and no more than 85° (20°≦|α|≦85°). If the absolute value of the incident angle α is less than 20°, the shadowing effect will be small, and silicon may be vapor-deposited in portions other than the bumps of the current collector 1, such that a sufficient interval may not be secured between active material members. On the other hand, if the absolute value of the incident angle α is greater than 85°, the proportion (W′/W) of the silicon amount W′ (=Wcos α) which is supplied onto the surface of the current collector 1 relative to the silicon amount W which has evaporated from the silicon evaporation source 31 will become very small, thus resulting in an increased material loss.

Now, with reference to FIGS. 5(a) and (b), an example of a negative electrode formed by using the above method will be described. FIG. 5(a) is a diagram showing an exemplary cross-sectional SEM image of active material members obtained with the above method, showing a state after the active material members have been formed but before the conductors 4 are vapor-deposited. FIG. 5(b) is a diagram showing an exemplary cross-sectional SEM image of active material complexes obtained with the above method.

Herein, a copper foil having a plurality of bumps 13 formed on its surface was used as the current collector 1, the plurality of bumps 13 being formed through rolling with a rolling roller having minute dents on its surface in advance. Each bump 13 was a quadrangular prism (height: 6 μm) with an upper face of a diamond shape (diagonal: 10 μm×20 μm). The bumps 13 were disposed with an interval of 20 μm along the longer diagonal, and 18 μm along the shorter diagonal, of the aforementioned diamond shape. Formation of the active material members 2 was performed by a method similar to the above-described method, with the incident angle α of silicon with respect to the normal direction N of the current collector 1 being 70°.

The resultant active material members 2 were disposed on the bumps 13 of the current collector 1, as shown in FIG. 5(a), and had a growth direction which was tilted from the normal direction of the current collector 1. Between adjoining bumps 13, regions 9 existed in which active material members (which herein is silicon oxide) had not grown due to the aforementioned shadowing effect, whereby a gap was obtained between adjoining active material members 2. The height of each active material member 2 was 10 μm.

On the active material members 2 as shown in the figure, conductors 4 were formed with a method similar to the above-described method, by using a titanium (Ti) evaporation source as the metal evaporation source 32, thus obtaining active material complexes 10. When forming the conductors 4, the incident angle β of titanium with respect to the normal direction N of the current collector 1 was 0°.

In each active material complex 10 obtained, as shown in FIG. 5(b), a conductor 4 of titanium had been formed on an upper portion of the side face and the upper face of the active material member 2 with a substantially uniform thickness. The conductor 4 had a thickness of 3.5 μm.

As in the examples shown in FIGS. 5(a) and (b), when a regular ruggedness pattern is formed on the surface of the current collector 1, the layout and interval of the active material members 2 can be adjusted by appropriately selecting the shape, size, arraying pitch, etc., of the bumps 13 in the ruggedness pattern. Doing so is advantageous because it can more effectively suppress deformation of the negative electrode due to expansion of the active material members 2.

The bumps 13 formed on the current collector 1 are not limited to the quadrangular prisms with upper faces of diamond shapes as those used in the example shown in FIG. 5, but may be selected as appropriate. Other than a diamond shape, an orthogonal projection image of the bump 13 as seen from the normal direction N of the current collector 1 may be a polygon such as a square, a rectangle, a trapezoid, or a parallelogram, a circle, an ellipse, or the like. The shape of their cross section parallel to the normal direction N of the current collector 1 may be a square, a rectangle, a polygon, a semicircular shape, or a shape which is a combination thereof. Moreover, the shape of the bumps 13 in a cross section perpendicular to the surface of the current collector 1 may be a polygon, a semicircular shape, an arc shape, or the like, for example. Note that, in the case where the boundaries between the bumps 13 and portions other than the bumps (also referred to as grooves, dents, etc.) are not clear, e.g., the cross section of the ruggedness pattern formed on the current collector 1 having a shape which is composed of curves, any portion of the entire surface having a ruggedness pattern that has an average height or more will be defined as a “bump 13”, whereas any portion that has less than the average height will be defined as a “groove” or “dent”.

In order to obtain voids by the shadowing effect, the height of the bumps 13 is preferably 3 μm or more. On the other hand, in order to ensure strength of the bumps 13, it is preferably 20 μm or less, and more preferably 15 μm or less.

Although there is no particular limitation, the width of the upper face of each bump 13 (largest width) is preferably 50 μm or less, whereby the deformation of the negative electrode 10 due to expansion stress of the active material members 2 can be more effectively suppressed. More preferably, it is 20 μm or less. On the other hand, the width of the upper face of each bump 13 is preferably 1 μm or more because, if the width of the upper face of each bump 13 is too small, a sufficient area of contact between the active material members 2 and the current collector 1 may not be obtained.

Furthermore, in the case where the bumps 13 are pillar-like members having side faces which are perpendicular to the surface of the current collector 1, the distance between adjoining bumps 13, i.e., the width of a groove, is preferably 30% or more, and more preferably 50% or more, of the width of each bump 13. As a result, sufficient voids are obtained between active material members 2 to greatly alleviate the expansion stress. On the other hand, if the distance between adjoining bumps 13 is too large, the height of the active material members 2 will be increased in order to ensure a capacity; therefore, the distance is preferably 250% or less, and more preferably 200% or less of the width of each bump 13. Note that the width of the upper face of a bump 13 and the distance between adjoining bumps 13 refer to, respectively, a width and a distance in a cross section which is perpendicular to the surface of the current collector 1 and contains the growth direction of the active material members 2.

The upper face of each bump 13 may be flat, but preferably has ruggednesses, preferably with a surface roughness Ra of no less than 0.3 μm and no more than 5.0 μm. When the upper face of each bump 13 has ruggednesses with a surface roughness Ra of 0.3 μm or more, the active material members 2 are easy to grow on the bumps 13, so that sufficient voids can be formed between active material members 2 with a certainty. On the other hand, the current collector 1 will become thick if the surface roughness Ra of the bumps 13 is too large; therefore, it is preferable that the surface roughness Ra 5.0 μm or less. Furthermore, when the surface roughness Ra of the current collector 1 is within the aforementioned range (no less than 0.3 μm and no more than 5.0 μm), a sufficient adhesion force can be obtained between the current collector 1 and the active material members 2, thus preventing peeling of the active material members 2.

Note that regular ruggednesses do not need to be formed on the surface of the current collector 1. For example, a metal foil having a roughened surface can be used as the current collector 1. Even in this case, it is preferable that the surface roughness Ra of the metal foil is no less than 0.3 μm and nom 5.0 μm. Moreover, in order to form active material members 2 on the surface of such a metal foil by oblique vapor deposition, it is preferable to prescribe the surface roughness of the metal foil to be 0.3 μm or more, and adjust the absolute value of the incident angle α of the material (e.g. silicon) of the active material members 2 with respect to the normal direction N of the current collector 1 to be 20° or more (|α|≧20°). If the surface roughness Ra is less than 0.3 μm or the absolute value of the incident angle θ is less than 20°, there is a possibility that sufficient masking effects may not be obtained. As a result, a plurality of active material members cannot be disposed with a sufficient interval, so that a continuous film may be formed, in which adjoining active material members are in contact with each other. Since such a continuous film hardly includes any space for absorbing the volume associated with an expansion of the active material, there is a possibility that the current collector may experience deformation or rupture due to the expansion stress of the active material at the time of charging.

Note that the method for forming the active material members 2 and the conductors 4 is not limited to an electron beam vapor deposition technique, but a sputtering technique, an ion plating technique, or the like may be adopted.

### Embodiment 2

Hereinafter, with reference to the drawings, a second embodiment of a negative electrode for a lithium secondary battery according to the present invention will be described.

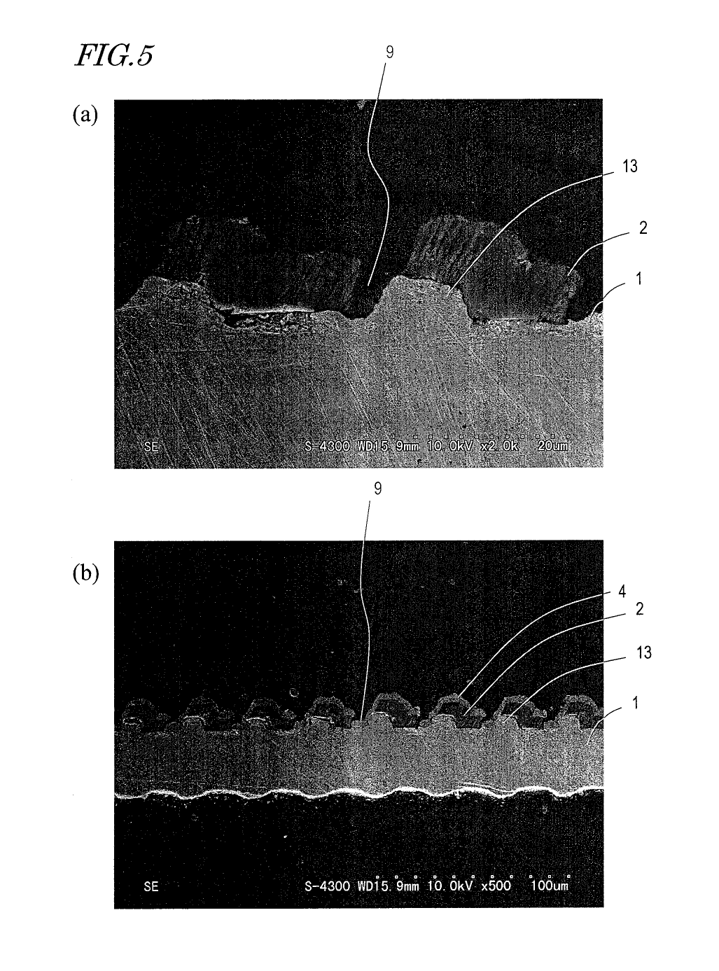

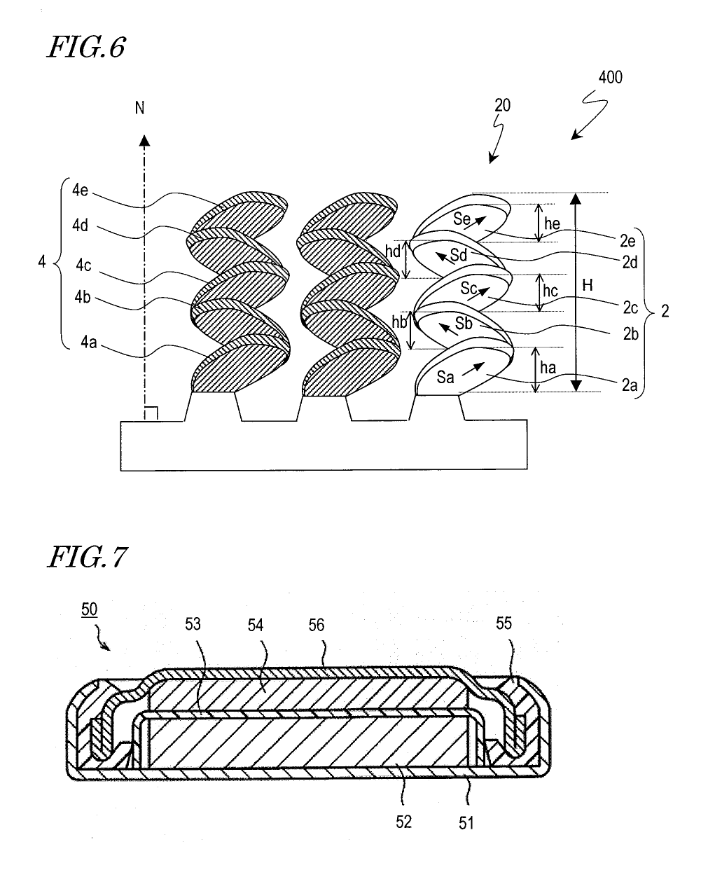

First, FIG. 6 is referred to. FIG. 6 is a schematic cross-sectional view of a negative electrode for a lithium secondary battery of the present embodiment. For simplicity, constituent elements which are similar to those of the negative electrode 100 shown in FIG. 1 will be denoted by like reference numerals, and the descriptions thereof will be omitted.

The negative electrode 400 includes a current collector 1, and a plurality of active material complexes 20 formed on the surface of the current collector 1. Each active material complex 20 has an active material member 2 which includes a plurality of active material portions 2a to 2e and a conductor 4 which includes a plurality of conductive portions 4a to 4e. The active material portions 2a to 2e are stacked on the surface of the current collector 1 in this order, and the conductive portions 2a to 2e are disposed in contact with the active material portions 2a to 2e, respectively. Moreover, the conductor 4 includes a portion which extends in a direction non-parallel to the surface of the current collector 10.

In the present embodiment, each of the plurality of active material portions 2a to 2e has growth directions Sa to Se, which are tilted with respect to the normal direction N of the current collector 1. Moreover, in the cross section shown in the figure, each of the plurality of conductive portions 4a to 4e is formed on an upper portion of the side face of the corresponding active material portion 2a to 2e. The lower portion of the side face of each active material portion 2a to 2e is not covered with a conductive portion.

In accordance with the negative electrode 400 of the present embodiment, as in the aforementioned negative electrode 100, non-uniformity in the moving speed of lithium ions occurring in the active material members 2 can be suppressed based on the conductors 4 extending non-parallel to the surface of the current collector 1. Thus, it is possible to suppress crack failures of the active material members 2 and peeling of the active material members 2 from the current collector 1 through repetitive charging and discharging. Even if an active material member 2 experiences a crack failure, electrical connection between the active material member 2 and the current collector 1 can be ensured on the basis of the conductor 4 which is in contact with the active material member 2.

Preferably, each of the conductive portions 4a to 4e of the present embodiment is disposed in proximity with another adjoining conductive portion, so that they are substantially equipotential. To be “disposed in proximity” means that the distance between the adjoining conductor portions is sufficiently small (e.g. ⅕ or less of the thickness H of the active material complex 20). More preferably, adjoining ones of the conductive portions 4a to 4e are disposed in contact with each other. As a result, the non-uniformity in the moving speed of lithium ions occurring in the active material portions 2a to 2e can be reduced more effectively. Moreover, even if a crack occurs in one active material portion, it is still possible to ensure electrical connection between an overlying active material portion and the current collector 1.

Preferably, the respective growth directions Sa to Se of the active material portions 2a to 2e are alternately tilted in opposite directions with respect to the normal direction N of the current collector 1. As a result, the expansion stress of the active material can be alleviated more effectively. Moreover, when the active material portions 2a to 2e have the aforementioned structure, by forming the conductive portions 4a to 4e on upper portions of the side faces and the upper faces of the respective active material portions 2a to 2e, a conductor 4 can be formed which extends in a zigzag manner from the bottom face of each active material complex 20 in a direction away from the current collector 1. As used herein, to “extend in a zigzag manner” means that the conductor 4 extends, in the interior of the active material complex 20, in a vertical direction from the surface of the current collector 1 while inverting its direction of tilt from the normal direction N of the current collector 1. It is possible to confirm such structures by performing a chemical etching for a polished cross section which is perpendicular to the surface of the current collector 1 and which contains the growth directions S and observing the resultant specimen, for example.

When the conductor 4 extends in a zigzag manner in the interior of the active material complex 20, it can more effectively function as a backbone for maintaining the shape of the active material complex 20, thus suppressing the autodestruction of the active material member 2 associated with repetitive charging and discharging. Moreover, since the conductors 4a to 4d can be disposed respectively at the interfaces between vertically-adjoining ones of the active material portions 2a to 2e, the active material portions 2a to 2e can be isolated from one another. As a result, the expansion stress occurring in the active material portions 2a to 2e can be effectively alleviated. Although it is preferable that the conductor 4 extends continuously in the interior of the active material complex 20, it is not necessary that all of the conductor portions 4a to 4e continue from one another; some of them may be discrete.

In the present embodiment, some parts of the conductors 4 are disposed at the interfaces between vertically-adjoining ones of the active material portions 2a to 2e, thus being located in the interior of the active material complex 20. Thus, when a part or a whole of the conductor 4 is located in the interior of the active material members complex 10, the strength of the active material member 2 can be ensured without preventing occlusion and release of lithium by the active material member 2 and the non-uniformity in the moving speed of lithium ions in the interior of the active material member 2, which is advantageous. As a method of forming the conductor 4 in the interior of the active material complex 20, after performing a vapor deposition step for an underlying active material portion, an electrically conductive material may be deposited on that active material portion to form a conductor portion, and then a vapor deposition step may be performed for an overlying active material portion on that conductor portion, for example. In the present specification, “a part or a whole of the conductor 4 being located in the interior of the active material complex 20” encompasses the case where a part of a whole of the conductor 4 is located at any interface between adjoining active material portions 2a to 2e.

In the present embodiment, at least one end of each conductive portion 4a to 4e is disposed on the side face of the active material complex 20. Moreover, vertically-adjoining ones of the conductive portions 4a to 4e come in contact at the side face of the active material complex 20, thus constituting bent portions of the conductor 4. With such a construction, the active material member 2 can be divided into more regions, so that the expansion stress of the active material member 2 can be effectively dispersed. Moreover, since the conductor 4 is formed across the entire width of each active material complex 20, it functions as a more firm backbone, thus being able to suppress cracking and pulverization of the active material complex 20 with a certainty.

Preferably, the respective thicknesses ha to he of the active material portions 2a to 2e are 0.2 μm or more. If the thicknesses ha to he are less than 0.2 μm, it will be necessary to increase the number of active material portions to be stacked in order to ensure a high capacity. On the other hand, in order to sufficiently suppress the non-uniformity in the moving speed of lithium ions occurring in the interior of each active material portion 2a to 2e, it is preferable that the respective thicknesses ha to he of the active material portions 2a to 2e are 10 μm or less. Note that, as will be described later, the active material portions 2a to 2e are respectively formed through first to fifth vapor deposition steps, and therefore the aforementioned thicknesses ha to he can be controlled based on the vapor deposition times, vapor deposition rates, and the like in the respective vapor deposition steps.

In the present embodiment, the number of active material portions 2a to 2e (number of layers) n composing each active material member 2 is preferably three or more. If it is two or less, there is a possibility that the effect of alleviating the expansion stress by stacking active material portions of different growth directions S may not be sufficiently obtained. The upper limit of the preferable range of the number of layers n can be calculated so as to satisfy the aforementioned preferable thickness H of the active material complex 20 and the aforementioned preferable thicknesses ha to he of the active material portions, e.g. fifty.

### <Method of Producing Negative Electrode 400>

With reference to the drawings, an exemplary method of producing the negative electrode 400 of the present embodiment will be described.

First, by a method similar to Embodiment 1, a sheet-like current collector 1 having bumps on its surface is produced. Next, by using the vapor deposition apparatus 300 which has been described with reference to FIGS. 4(a) and (b), active material complexes 20 are formed on the surface of the current collector 1.

Specifically, the current collector 1 is placed on the platform 40 of the vapor deposition apparatus 300, and silicon oxide is grown on the surface of the current collector 1 by a method similar to the method described in Embodiment 1. Similarly to Embodiment 1, the tilting angle θ of the platform 40 with respect to the horizontal plane 45 is chosen so that 20°≦|θ|≦85°. In the present embodiment, the tilting angle θ is 70°. Therefore, the incident angle α of silicon with respect to the normal direction N of the current collector 1 is 70°. In this manner, active material portions 2a having a growth direction Sa which is tilted with respect to the normal direction N of the current collector 1 are formed (first active material vapor deposition step).

Next, on the current collector 1 having the active material portions 2a formed thereon, nickel is grown by a method similar to the method described in Embodiment 1. Similarly to Embodiment 1, the tilting angle φ of the platform 40 with respect to the horizontal plane 45 is chosen so that |φ|<|θ|. In the present embodiment, the tilting angle φ is 0°. As a result, nickel strikes the surface of the current collector 1 in the normal direction N of the current collector 1 (incident angle of nickel β=0°). In this manner, conductive portions 4a of nickel are formed on upper portions of the side faces and the upper faces of the active material portions 2a (first conductors vapor deposition step).

Next, the platform 40 is again rotated around its rotation axis so as to be tilted with respect to the horizontal plane 45 in the opposite direction of the tilting direction of the platform 40 in the first active material vapor deposition step, by e.g. 70° (θ=−70°). In this state, while supplying high-purity oxygen onto the surface of the current collector 1, the silicon evaporation source 31 is irradiated with an electron beam, thus allowing silicon to strike the surface of the current collector 1. The incident angle α of silicon is equal to the aforementioned tilting angle θ, i.e., 70° (α=−70°).

At this time, due to the aforementioned shadowing effect, silicon atoms selectively strike the conductors 4a having been formed on the current collector 1, whereby silicon oxide grows on the conductors 4a, so that active material portions 2b are obtained (second active material vapor deposition step). With respect to the normal direction N of the current collector 1, the growth direction Sb of the active material portions 2b is tilted toward the opposite side from the growth direction Sa of the active material portions 2a.

Next, by a method similar to the first conductor vapor deposition step, nickel is grown on the active material portions 2b. In the present embodiment, the tilting angle φ is 0°. Therefore, nickel strikes the surface of the current collector 1 in the normal direction N of the current collector 1 (incident angle of nickel β=0°). In this manner, conductive portions 4b of nickel are formed on upper portions of the side faces and the upper faces of the active material portions 2b (second conductors vapor deposition step).

Thereafter, the tilting angle θ of the platform 40 is set back to the same angle (θ=70°) as in the first active material vapor deposition step, and silicon oxide is grown under conditions similar to those in the first active material vapor deposition step (third active material vapor deposition step). As a result, active material portions 2c are formed on the conductive portions 4b. Then, a vapor deposition of nickel is performed by a method similar to the first conductor vapor deposition step (third conductors vapor deposition step).

In this manner, by alternating five active material vapor deposition steps and five conductor vapor deposition steps, for example, as shown in FIG. 6, active material complexes 20 are obtained each having five active material portions 2a to 2e and conductive portions 4a to 4e respectively formed on the active material portions 2a to 2e. Note that, by alternately switching the tilting angles θ in the first to fifth active material vapor deposition steps between 70° and −70°, for example, active material complexes 20 which extend in a zigzag manner from the surface of the current collector 1 can be formed. Although there is no particular limitation, it is preferable that the vapor deposition time in each active material vapor deposition step is set substantially equal.

Preferably, the incident angle α of silicon in each active material vapor deposition step is chosen so that 20°≦|α|≦85°. Moreover, it is preferable that the absolute values of the incident angle α in the first to fifth active material vapor deposition steps are equal. On the other hand, it is preferable that the incident angle β of nickel in each conductor vapor deposition step is chosen so that |β|<|α|. As a result, nickel can be surely deposited in an upper portion of the side face of each underlying active material portion, so that a conductive portion which extends in a direction non-parallel to the surface of the current collector 1 along the side face of the active material portion can be formed.

Although nickel (Ni) is used as the material of the conductors in the above method, other metals which do not form an alloy with lithium may be used instead. For example, a metal whose main component is Ti, Cu, Zr, Cr, Fe, Mo, Mn, Nb or V can be used. Alternatively, instead of a metal, an electrically conductive ceramic whose main component is a nitride of Ti or a nitride of Zr may be used. A sputtering technique, an ion plating technique, or the like can be used to perform formation of conductors containing a nitride of Ti or a nitride of Zr. For example, using a metal which is either Ti or Zr as a target, a sputtering may be performed in an argon ambient containing 5 to 10% nitrogen, whereby a nitride of Ti or Zr can be deposited on the current collector having active material members (or active material portions) formed thereon (reactive sputtering). Alternatively, by using Ti or Zr as an evaporation source (metal material), an ion plating technique may be performed in a nitrogen gas. In this case, the conductors contain a Ti nitride or a Zr nitride and have electrically conductivity, and may contain Ti or Zr in addition to Ti nitride (TiN) or Zr nitride (ZrN).

Moreover, in the present embodiment, so long as active material vapor deposition steps and conductor vapor deposition steps alternately take place, the order of performing these steps may be changed. In the aforementioned method, a plurality of active material vapor deposition steps are performed while switching the evaporation direction, and an electrically conductive material is vapor-deposited after each active material vapor deposition step; however, it is not necessary that an electrically conductive material be vapor-deposited after every active material vapor deposition step. For example, the aforementioned effect of ensuring electrical connection between the active material members and the current collector and the effect of reducing non-uniformity in the moving speed of lithium ions can be obtained also in the case where an electrically conductive material is vapor-deposited after at least one active material vapor deposition step, among a plurality of active material vapor deposition steps. However, it is preferable to vapor-deposit an electrically conductive material every time an active material vapor deposition step is performed. The reason is that, since conductors which extend continuously from the surface of the current collector 1 onto the upper faces of the active material members can be formed, the aforementioned effect can be exhibited with a greater certainty, whereby better cycle characteristics can be realized.

### <Construction of Lithium Secondary Battery>

Next, with reference to the drawings, an exemplary construction of a lithium-ion secondary battery which is obtained with the negative electrode 400 of the present embodiment will be described.

FIG. 7 is a schematic cross-sectional view illustrating an exemplary coin-type lithium-ion secondary battery in which the negative electrode 400 is employed. The lithium-ion secondary battery 50 has an electrode group including a positive electrode 52, a negative electrode 54, and a separator 53 provided between the negative electrode 54 and the positive electrode 52, and the electrode group is impregnated with an electrolyte (not shown) which has lithium-ion conductivity. The positive electrode 52 is electrically connected with a positive electrode case 51 which serves also as a positive terminal, whereas the negative electrode 54 is electrically connected with a sealing plate 56 which serves also as a negative terminal. Moreover, the open end of the positive electrode case 51 is crimped to a gasket 55 which is provided at the periphery of the sealing plate 56, whereby the entire battery is sealed. The construction of the negative electrode 54 is similar to the construction described above with reference to FIG. 7, for example.

Although FIG. 7 illustrates an example of a coin battery, the shape of the lithium secondary battery of the present invention is not limited to a coin-type, but may be a button-type, a sheet-type, a cylindrical-type, a flat-type, prismatic-type, or the like. The lithium secondary battery of the present invention should include the negative electrode 100 or 400 as has been described above with reference to FIG. 1 and FIG. 6, but the constituent elements other than the negative electrode are not particularly limited. As the material of the current collector of the positive electrode, Al, an Al alloy, Ti, or the like may be used. As the active material layer (positive-electrode active material layer) of the positive electrode, a lithium-containing transition metal oxide such as lithium cobaltate (LiCoO₂), lithium nickelate (LiNiO₂), or lithium manganate (LiMn₂O₄) can be used. The positive-electrode active material layer may be composed only of a positive-electrode active material, or include a mixture which contains a positive-electrode active material, a binder agent, and a conductive agent. Furthermore, the positive-electrode active material layer can be composed of a plurality of pillar-like active material members. As the lithium-ion conductive electrolyte, various solid electrolytes or nonaqueous electrolyte solutions having lithium-ion conductivity may be used. As the nonaqueous electrolyte solution, what is obtained by dissolving a lithium salt in a nonaqueous solvent is preferably used. There is no particular limitation as to the composition of the nonaqueous electrolyte solution. Furthermore, there is no particular limitation as to the material of the separator 53, and any material that is used for lithium secondary batteries of various forms can be used.

The shape and construction of an active material complex according to the present embodiment are not limited to the shape and construction of an active material complex as shown in FIG. 6. By appropriately adjusting the incident angle α of an active material such as silicon, the incident angle β of an electrically conductive material such as nickel, the film formation time, the number of layers n, etc., active material complexes having various shapes and constructions can be formed. Even in such cases, the effects of the present invention can be obtained so long as, in an active material complex, the conductor is in contact with the active material member and extends non-parallel to the current collector surface. Hereinafter, specific examples will be described with reference to the drawings.

FIG. 8 to FIG. 10 are schematic cross-sectional views showing other examples of the negative electrode of the present embodiment. For simplicity, constituent elements which are similar to those in FIG. 1 will be denoted by like reference numerals, and the descriptions thereof will be omitted.

In a negative electrode 500 shown in FIG. 8, active material complexes 20 each tilted in one direction are formed on bumps 13 of a current collector 1. Each active material complex 20 includes a plurality of active material portions 2a to 2c and conductive portions 4a to 4c formed on upper portions of the side faces and the upper faces of the active material portions 2a to 2c, respectively. In the negative electrode 500, the growth directions of the plurality of active material portions 2a to 2c are all tilted in the same direction with respect to the normal direction N of the current collector 1. Moreover, adjoining conductive portions 4a to 4c are in contact with each other, thus composing a conductor 4 extending from the bottom face to the upper face of each active material complex 20. Furthermore, some parts of the conductive portions 4a to 4b are disposed at the interfaces between vertically-adjoining ones of the active material portions 2a to 2c.

The negative electrode 500 can be produced by using the vapor deposition apparatus 300 which has been described with reference to FIGS. 4(a) and (b), by a method similar to the aforementioned production method for the negative electrode 400. However, the incident directions of silicon when forming the active material portions 2a to 2c all need to be set in the same direction with respect to the normal direction N of the current collector 1. For example, the incident angles α of silicon when forming the active material portions 2a to 2c may all be set to 70°.

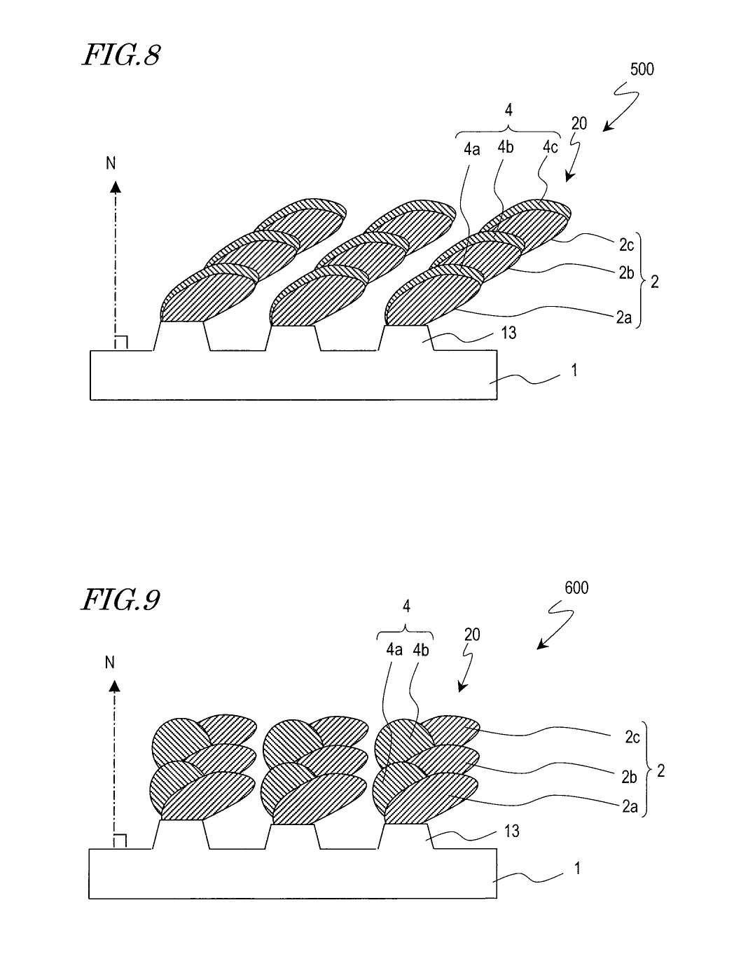

In a negative electrode 600 shown in FIG. 9, active material complexes 20 having a structure in which active material portions and conductive portions are alternately stacked are formed on bumps 13 of a current collector 1. In the illustrated example, three layers of active material portions 2a to 2c are formed, their growth directions being tilted in the same direction with respect to the normal direction N of the current collector 1. With respect to the normal direction N of the current collector 1, a conductive portion 4a which is disposed between the active material portions 2a and 2b and a conductive portion 4b which is disposed between the active material portions 2b and 2c are both tilted toward the opposite side from the active material portions 2a to 2c.

The negative electrode 600 can be produced using the vapor deposition apparatus 300 which has been described with reference to FIGS. 4(a) and (b), by alternating active material vapor deposition steps and conductor vapor deposition steps. However, assuming that the incident angle α of silicon when forming the active material portions 2a to 2c is no less than 20° and no more than 85°, the incident angle β of the electrically conductive material when forming the conductive portions 4a and 4b is chosen in a range of no less than −85° and no more than −20°. In the illustrated example, the incident angle α of silicon and the incident angle β of the electrically conductive material are chosen so as to satisfy the relationship −α<β0<α.

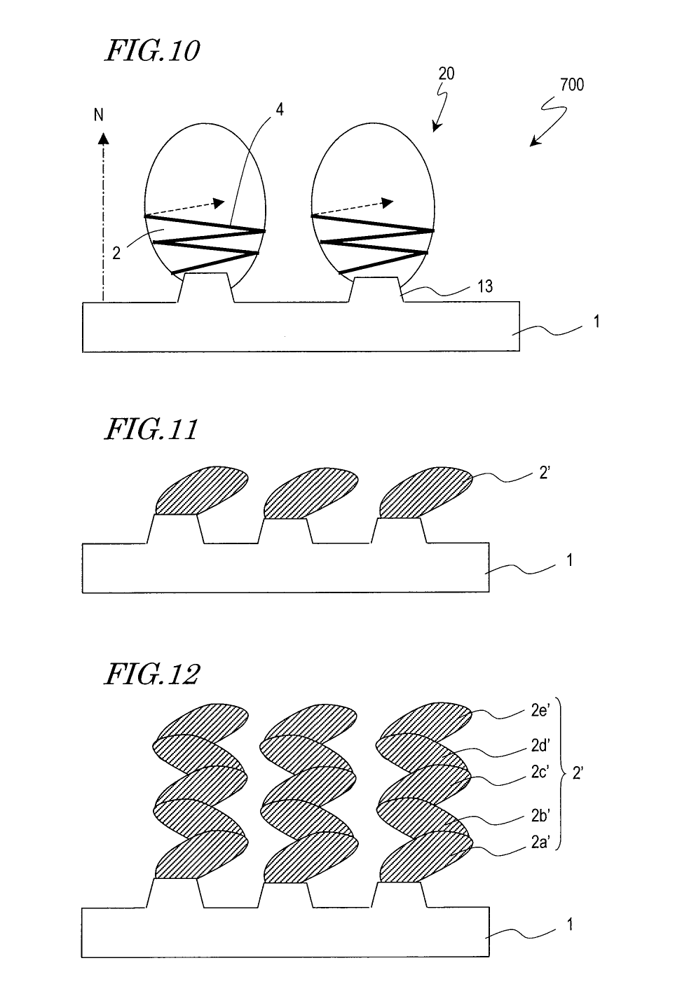

A negative electrode 700 shown in FIG. 10 differs from the negative electrode 400 shown in FIG. 6 in that the number of layers n in each active material complex 20 is large (e.g. 30 or more). As shown in the figure, when the number of layers is increased, the cross-sectional shape of each active material complex 20 may no longer be a zigzag shape that is tilted along the growth direction of each active material portion, but may be a pillar shape which stands upright along the normal direction N of the current collector 1, for example. Even in such cases, by forming a conductive portion on each active material portion, a conductor 4 which extends in a zigzag manner from the bottom face to the upper face of the active material complex 20 can be formed.

In each of the negative electrodes 500 to 700 shown in FIG. 8 to FIG. 10, as in the negative electrode 400 shown in FIG. 6, each of the plurality of conductor portions is in contact with an active material portion, and has a potential which is approximately equal to that of the current collector 1. Therefore, the moving speeds of lithium ions in the interior of each active material portion and at the interface between the active material portion and the electrolyte solution can be made substantially uniform, which is advantageous. Moreover, electrical contact between the active material portions and the current collector 1 can be ensured more effectively. Therefore, when a lithium secondary battery is constructed by using the negative electrode 400, the charge-discharge cycle characteristics can be greatly improved over the conventional level.

### EXAMPLES AND COMPARATIVE EXAMPLES

Examples of the negative electrode according to the present invention and Comparative Examples will be described. In Examples 1-1 to 1-3, sample negative electrodes having a similar construction to that of the negative electrode 100 of Embodiment 1 was provided, whereas in Example 2, a sample negative electrode having a similar construction to that of the negative electrode 400 of Embodiment 2 was produced. The number of layers n of active material portions in the sample negative electrode of Example 2 was five. Furthermore, in Example 3, a sample negative electrode having conductors made of an electrically conductive ceramic (Ti nitride) was produced. As Comparative Examples 1 to 3, sample negative electrodes having no conductors were produced. Next, sample cells for evaluation were produced by using the resultant sample negative electrodes of the Examples and the Comparative Examples, and their characteristics were evaluated.

Hereinafter, the production methods for the sample negative electrodes of the Examples and the Comparative Examples, the production method for the sample cells for evaluation, and the evaluation method and evaluation results of the sample cells will be described.

### Production Method of Sample Negative Electrode

### (i) Example 1-1

In Example 1-1, as a current collector, a copper foil was used which was obtained by forming, through rolling with a rolling roller having minute dents on its surface in advance, a plurality of bumps 13 on the surface of a rolled copper foil having a core thickness of 35 μm. Each bump 13 was a quadrangular prism (height: 6 μm) with an upper face of a diamond shape (diagonal: 10 μm×20 μm). The bumps 13 were disposed with an interval of 20 μm along the longer diagonal, and 18 μm along the shorter diagonal, of the aforementioned diamond shape. On this rolled copper foil, active material members and conductors were formed by a method described below, by using the vapor deposition apparatus 300 shown in FIGS. 4(a) and (b).

FIG. 4(a) is referred to again. First, 50 g of silicon with a purity of 99.9999% was accommodated in the silicon evaporation source 31 of the vapor deposition apparatus 300, and 150 g of nickel with a purity of 99.9% was accommodated in the metal evaporation source 32. Moreover, the current collector 1 was placed on the platform 40, and the tilting angle θ of the platform was adjusted (θ=70°) so that silicon would strike the surface of the current collector 1 at an angle tilted by 70° with respect to the normal direction N of the current collector 1 (α=70°. Thereafter, the lid of the chamber 30 was closed.

After reducing the pressure inside the chamber 30 to 7×10⁻⁵ Pa, oxygen was introduced via a mass flow controller, and the pressure within the chamber 30 was adjusted to 4.5×10⁻³ Pa. Moreover, the current collector 1 was heated to 200° C. by using the heater 35 for heating the current collector.

Next, the silicon evaporation source 31 was irradiated with electrons at an acceleration voltage of 10 kV to heat and melt the silicon, and in a state where the mass flow controller was adjusted so that the oxygen pressure in the chamber 30 was 4.5×10⁻³ Pa, the rate monitor 36 was set so that the actual film formation rate would be 0.45 nm/second, and thus the silicon evaporation source 31 was left for 90 minutes. Thereafter, the shutter 38 was opened for 110 minutes to allow silicon oxide to grow on the current collector 1 via reactive evaporation. At this time, the electron gun output current was 450 mA, and the oxygen flow rate was 7 sccm. Thereafter, the heater 35 for heating the current collector was turned off to cool the current collector 1 to a temperature or 100° C. or less. Next, nitrogen was introduced into the chamber 30 to bring the interior of the chamber 30 to atmospheric pressure, and the lid of the chamber 30 was opened.

Next, as shown in FIG. 4(b), the metal evaporation source 32 was moved under the platform 40, and the tilting angle φ of the platform 40 was adjusted so that nickel atoms evaporating from the metal evaporation source 32 would strike the current collector 1 in the normal direction N of the current collector 1 (incident angle of nickel β=0°). Thereafter, the lid of the chamber 30 was closed.

Next, after reducing the pressure inside the chamber 30 to 7×10⁻⁵ Pa, argon was introduced via a mass flow controller, and the pressure in the vacuum container was adjusted to 1×10⁻³ Pa. Moreover, the current collector 1 was heated to 200° C. by using the heater 35 for heating the current collector.

Then, the metal evaporation source 32 was irradiated with electrons at an acceleration voltage of 10 kV to heat and melt the nickel; the rate monitor 37 was set so that the actual film formation rate would be 0.5 nm/second; and thus the metal evaporation source 32 was left for 90 minutes. Thereafter, the shutter was opened for 20 minutes to deposit nickel on the silicon oxide. At this time, the electron gun output current was 300 mA. Thereafter, the power for the heater 35 for heating the current collector was turned off to cool the current collector 1 to a temperature of 100° C. or less. Then, nitrogen was introduced to the chamber 30 to bring the interior of the chamber 30 to atmospheric pressure, and the lid was opened.

In this manner, on the current collector 1, active material complexes including active material members of silicon oxide and conductors of nickel were formed, thus obtaining the sample negative electrode of Example 1-1.

### (ii) Example 1-2

Except that a titanium (Ti) evaporation source was used as the metal evaporation source 32, active material complexes including active material members of silicon oxide and conductors of titanium were formed on the current collector 1 by a method similar to that of Example 1-1, thus obtaining the sample negative electrode of Example 1-2.

### (iii) Example 1-3

Except that a copper (Cu) evaporation source was used as the metal evaporation source 32, active material complexes including active material members of silicon oxide and conductors of copper were formed essentially by a method similar to that of Example 1-1, thus obtaining the sample negative electrode of Example 1-3. In order to prevent the evaporating copper from fusing onto a copper crucible, the evaporating copper was placed in the copper crucible while kept in a small carbon container.

### (iv) Example 2

On the surface of a current collector similar to the current collector 1 used in Example 1-1, active material portions and conductive portions were alternately formed by using the vapor deposition apparatus 300 shown in FIGS. 4(a) and (b).

Specifically, first, by a method similar to that of Example 1-1, silicon oxide and nickel were vapor-deposited in this order on the current collector 1 (first active material vapor deposition step and first conductors vapor deposition step). Next, the current collector 1 was placed on the platform 40, and the tilting angle θ of the platform 40 was adjusted so that the incident angle α of silicon atoms was −70°. Thereafter, the lid of the chamber 30 was closed, and silicon oxide was further grown on the nickel (second active material vapor deposition step). Except for the incident angle α of silicon atoms, the second active material vapor deposition step was performed under conditions similar to those of the first active material vapor deposition step. In this manner, five active material vapor deposition steps and five conductor vapor deposition steps were alternately performed (first to fifth active material vapor deposition steps and first to fifth conductors vapor deposition steps). The third and fifth active material vapor deposition steps were performed under conditions similar to those of the first active material vapor deposition step (incident angle of silicon α=70°), whereas the fourth active material vapor deposition step was performed under conditions similar to those of the second active material vapor deposition step (incident angle of silicon α=−70°). Moreover, the second and subsequent conductor vapor deposition steps were all performed under conditions similar to those of the first conductor vapor deposition step (incident angle of nickel β=0°.

In this manner, on the current collector 1, active material complexes in which five active material portions of silicon oxide and five conductive portions of nickel were alternately stacked were formed, thus obtaining the sample negative electrode of Example 2.

### (v) Comparative Example 1

By using a current collector 1 similar to that of Example 1-1, active material members were formed on the current collector 1 by a method similar to that of Example 1-1, but the subsequent conductor vapor deposition step was not performed. As a result, as shown in FIG. 11, a negative electrode was obtained in which a plurality of active material members 2′ were formed at an interval on the current collector 1. This negative electrode was designated the sample negative electrode of Comparative Example 1.

### (vi) Comparative Example 2

By using a current collector 1 similar to that of Example 1-1, first to fifth active material vapor deposition steps were performed by a method similar to that of Example 2. However, no conductor vapor deposition steps were performed. As a result, as shown in FIG. 12, active material members 2s′ constructed by stacked active material portions 2a′ to 2e′ were formed at an interval on the current collector 1. The negative electrode shown in the figure was designated the sample negative electrode of Comparative Example 2.

### (vii) Example 3

On the surface of a current collector 1 which was obtained by allowing copper to deposit by electrolytic technique on the surface of the current collector used in Example 1-1, active material members of silicon were formed by using the vapor deposition apparatus 300 shown in FIG. 4(a). Formation of the active material members was performed by a method and conditions similar to those of Example 1-1, except that oxygen was introduced at a flow rate of 0 sccm.

Next, by using a sputtering apparatus, conductors of Ti nitride were formed on the active material members. The method of formation will be described in detail below.

FIG. 15 is a schematic cross-sectional view of a sputtering apparatus which was used for the formation of conductors in the present Example.

The sputtering apparatus 800 includes a chamber 60, a valve 69, a low-vacuum pump and a high-vacuum pump 68 and 67, mass flow controllers 65 and 66, and an RF power supply 70. In the interior of the chamber 60, a specimen holder 63, a backing plate 62, and a target 61 which is attached on the backing plate 62 are disposed. Although not particularly shown, the face of the backing plate 62 on which the target is not attached is cooled with cooling water at a sufficient flow rate. In the present Example, a piece of metal Ti having a diameter of 250 mm was used as the target 61. The distance between the surface of the target 61 and the specimen holder 63 was 7 cm.

First, the current collector (hereinafter referred to as “specimen”) 64 on which the active material members had been formed by the above method was attached onto the specimen holder 63 in the chamber 60 so that active material member surfaces (silicon faces) would face the target 61.

Next, as a preparation for film formation, the pressure in the chamber 60 was reduced to 10⁻⁵ Pa by using the low-vacuum pump 68 and the high-vacuum pump 67. Thereafter, Ar was introduced at a flow rate of 24 sccm and N₂ was introduced at a flow rate of 2.6 sccm into the chamber 60, thereby adjusting the pressure within the chamber 60 to 0.7 Pa. The flow rates of Ar and N₂ were controlled by using the Ar mass flow controller 65 and the N₂ mass flow controller 66, respectively.

Next, an electric power of 1 kW, 13.56 MHz was applied to the target 61 by using the RF power supply 70. After visually confirming that a plasma had been excited, it was left for 30 minutes to become stable. Next, the shutter 71 was opened for 4 hours, thereby forming conductors having a thickness of 1.5 μm and containing Ti nitride as a main component on the surface of the specimen 64.

After formation of the conductors was finished, cooling was conducted for 1 hour. After the cooling, the specimen 64 was taken out of the chamber 60. In this manner, the sample negative electrode of Example 3 was obtained.

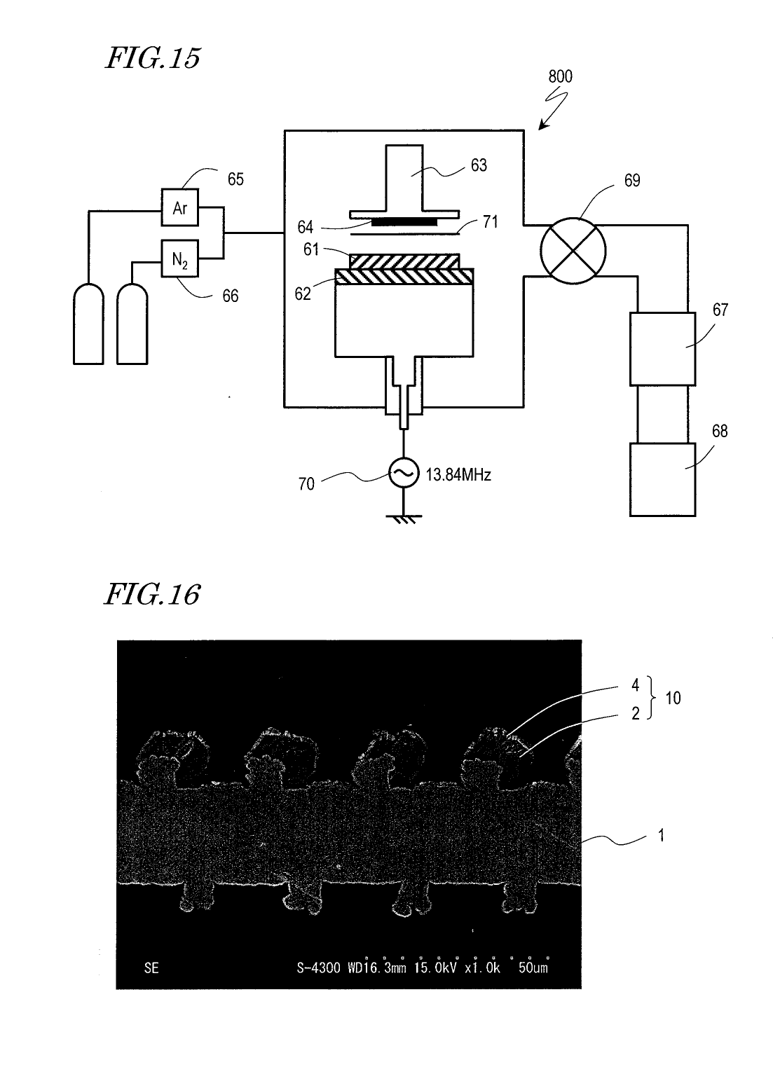

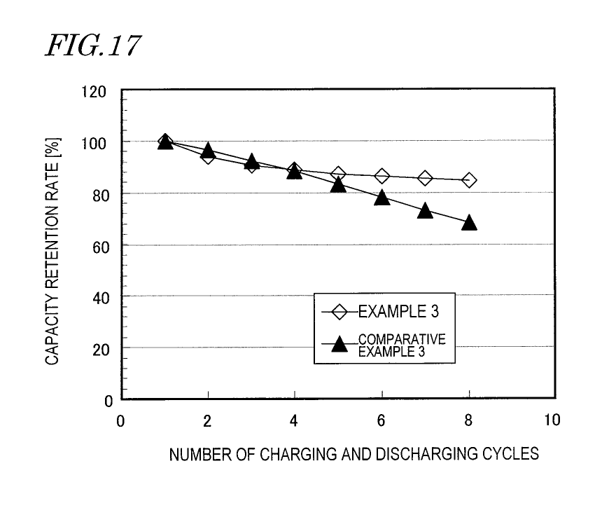

FIG. 16 is a cross-sectional SEM image of the sample negative electrode of Example 3. It can be confirmed from FIG. 16 that active material complexes 10 composed of active material members 2 and conductors 4 were obtained on the current collector 1. It can also be seen that the conductors 4 extend from the surface of the current collector 1 along the side faces of the active material members 2.

### (viii) Comparative Example 3

The sample negative electrode of Comparative Example 3 was produced by a method similar to that of Example 3 except that conductors of Ti nitride were not formed.

### <Production Method of Sample Cells for Evaluation>

The sample negative electrodes of the Examples and the Comparative Examples produced by the above methods were each cut out into a circular shape having a diameter of approximately 6.7 mm, thus becoming a negative electrode for a cell. By using each negative electrode for a cell, a sample cell for evaluation having the construction described above with reference to FIG. 7 was produced. In each sample cell, a metal lithium plate having a diameter of 11 mm was used as the positive electrode. As the electrolyte solution, a nonaqueous electrolyte solution was used which had been adjusted to 1 litter by dissolving 1 mol LiPF₆ into a mixed solvent of 30 vol % ethylene carbonate, 50 vol % methyl ethyl carbonate, and 20 vol % diethyl carbonate.

### <Evaluation Method and Results of Sample Cells>

### (I) Evaluations of Sample Cells of Examples 1-1 to 1-3 and Comparative Example 1

The sample cells of Examples 1-1 to 1-3 and Comparative Example 1 obtained by the above methods were subjected to a charging and discharging cycle test under the following conditions, and the relationship between the number of cycles and the capacity retention rate was measured. Herein, the “capacity retention rate” refers to a rate of an actually-measured discharge capacity in each cycle relative to a reference capacity, where the reference capacity is a maximum discharge capacity observable in a charging and discharging cycle test.

In the charging and discharging cycle test, charging and discharging under mode 1 and mode 2 as shown in Table 1 were performed in this order in one cycle, and this was repeated. In each cycle, an amount of charge until reaching an end voltage in the charging and discharging under mode 1 or mode 2 was measured, and a total value of these amounts of charge was defined as the actually-measured discharge capacity in this cycle. Note that the charging and discharging current values under mode 1 (1.6 mA) were determined by performing a capacity measurement by using a separate sample with charging and discharging currents of 10 μA, based on a 1C-equivalent current with respect to its discharge capacity, 1.6 mAh, in the first run.

TABLE 1

| | mode 1 | mode 2 |
|---|---|---|
| | (current/end | (current/end |
| | voltage) | voltage) |
| charging | 1.6 mA/0 V | 16 μA/0 V |
| discharging | 1.6 mA/1 V | 16 μA/1 V |

| | |
|---|---|
| pause time between | 10 minutes |
| charging and | |
| discharging | |
| ambient temperature | 20° C. |

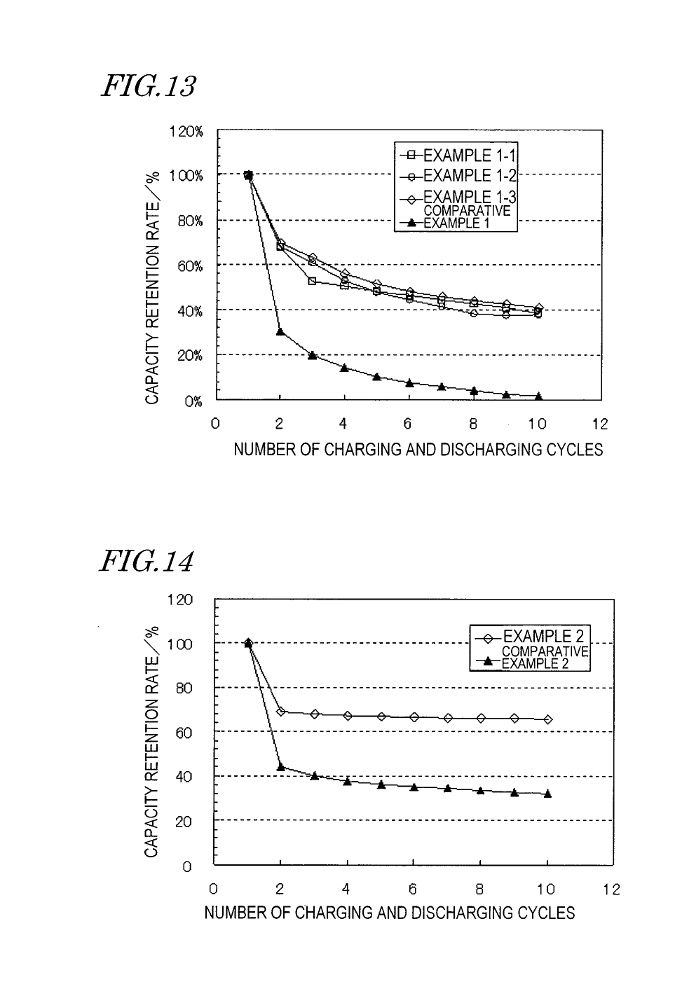

The measurement results are shown in FIG. 13. FIG. 13 is a graph showing a relationship between the number of cycles and the capacity retention rate with respect to each of the sample cells of Examples 1-1 to 1-3 and Comparative Example 1. It was found from these results that, although the capacity retention rate is lowered to 10% at the fifth cycle in the sample cell of Comparative Example 1, the sample cells of Examples 1-1 to 1-3 maintain an about 40% capacity even after repeating 10 cycles. Thus, it was confirmed that the cycle characteristics can be greatly improved by forming conductors on the active material members of the negative electrode. It was also found that similar effects can also be obtained when any one of nickel, titanium, and copper is used as the material of the conductors.

### (II) Evaluations of Sample Cells of Example 2 and Comparative Example 2

The sample cells of Example 2 and Comparative Example 2 obtained by the above methods were subjected to a charging and discharging cycle test under the following conditions, and the relationship between the number of cycles and the capacity retention rate was measured.

In the charging and discharging cycle test, charging and discharging under mode 1 and mode 2 as shown in Table 2 were performed in this order in one cycle, and this was repeated. For each cycle, an actually-measured discharge capacity was determined by a method similar to (I) above, and a capacity retention rate was calculated. Note that the charging and discharging current values under mode 1 (3.2 mA) were determined by performing a capacity measurement using a separate sample with charging and discharging currents of 10 μA, based on a 0.5 C-equivalent current with respect to its discharge capacity, 6.4 mAh, in the first run.

TABLE 2

| | mode 1 | mode 2 |
|---|---|---|
| | (current/end | (current/end |
| | voltage) | voltage) |
| charging | 3.2 mA/0 V | 32 μA/0 V |
| discharging | 3.2 mA/1 V | 32 μA/1 V |

| | |
|---|---|
| pause time between | 10 minutes |
| charging and | |
| discharging | |
| ambient temperature | 20° C. |

The measurement results are shown in FIG. 14. FIG. 14 is a graph showing a relationship between the number of cycles and the capacity retention rate with respect to each of the sample cells of Example 2 and Comparative Example 2. It was found from these results that, although the capacity retention rate is lowered to 40% or less at the third cycle in the sample cell of Comparative Example 2, the sample cell of Example 2 maintains a 60% capacity or more even after repeating 10 cycles. This is presumably because cracking of active material members or their breaking away from the current collector has caused a lowering of the capacity of the sample negative electrode of Comparative Example 2, whereas a lowering of capacity due to cracking or breaking away of the active material members has been suppressed by the conductors in the sample negative electrode of Example 2.

It was confirmed from these measurement results that the charge-discharge cycle characteristics of a lithium secondary battery can be greatly improved by, in a negative electrode having a plurality of active material members on the surface of a current collector, forming a conductor so as to be in contact with each active material member.

### (III) Evaluations of Sample Cells of Example 3 and Comparative Example 3

The sample cells of Example 3 and Comparative Example 3 obtained by the above methods were subjected to a charging and discharging cycle test under the following conditions, and the relationship between the number of cycles and the capacity retention rate was measured.

In the charging and discharging cycle test, charging and discharging under mode 1 and mode 2 as shown in Table 3 were performed in this order in one cycle, and this was repeated. For each cycle, an actually-measured discharge capacity was determined by a method similar to (I) and (II) above, and a capacity retention rate was calculated. Note that the charging and discharging current values under mode 1 (1 mA) were determined by performing a capacity measurement using a separate sample with charging and discharging currents of 10 μA, based on its discharge capacity of 1 mAh in the first run.

TABLE 3

| | mode 1 | mode 2 |
|---|---|---|
| | (current/end | (current/end |
| | voltage) | voltage) |
| charging | 1 mA/0 V | 100 μA/0 V |
| discharging | 1 mA/1.5 V | 100 μA/1.5 V |

| | |
|---|---|
| pause time between | 10 minutes |
| charging and | |
| discharging | |
| ambient temperature | 25° C. |

The measurement results are shown in Table 4 and FIG. 17. FIG. 17 is a graph showing a relationship between the number of cycles and the capacity retention rate with respect to each of the sample cells of Example 3 and Comparative Example 3.

TABLE 4

| number of charging | Example 3 | Comparative Example 3 |
|---|---|---|
| and discharging | capacity retention | capacity retention |
| cycles | rate (%) | rate (%) |
| 1 | 100.0 | 100.0 |
| 2 | 93.8 | 96.4 |
| 3 | 90.7 | 92.4 |
| 4 | 88.7 | 88.2 |
| 5 | 87.1 | 83.4 |
| 6 | 86.2 | 78.2 |
| 7 | 85.3 | 73.2 |
| 8 | 84.6 | 68.3 |

It was found from the results shown in Table 4 and FIG. 17 that, although the capacity retention rate is lowered to 68% at the eighth cycle in the sample cell of Comparative Example 3, the sample cell of Example 3 maintains an 84% capacity. This is presumably because cracking of active material members or their breaking away from the current collector has caused a lowering of the capacity of the sample negative electrode of Comparative Example 3, whereas a lowering of capacity due to cracking or breaking away of the active material members has been suppressed by the conductors in the sample negative electrode of Example 3.

Note that the charge-discharge characteristics of the sample cells of Example 3 and Comparative Example 3 are better than the charge-discharge characteristics of the sample cells of Examples 1-1 to 1-3 and Comparative Example 1 described above. This is presumably because, while the copper foils used in Examples 1-1 to 1-3 and Comparative Example 1 were rolled copper foils, those used in Example 3 and Comparative Example 3 had copper depositing on their surface by electrolytic technique.

As shown in FIG. 5(a), in the copper foils used in Examples 1 and 2, the side face of each protrusion has a small angle of about 60° with respect to the copper foil plane. On the other hand, as shown in FIG. 16, in the copper foils used in Example 3 and Comparative Example 3, it has a large angle of approximately 90° or more with respect to the copper foil plane. Presumably, such a difference in shape is caused by allowing copper to deposit on a rolled copper foil by electrolytic technique. In the case where active material members are formed on a protrusion surface which is rich with such ruggednesses (i.e., Example 3 and Comparative Example 3), a so-called anchoring effect acts on the active material members, whereby the adhesion force between the active material members and the copper foil increases. It is inferred that this suppresses detachment of the active material members from the copper foil, and provides a certain degree of improvement of capacity retention rate even in Comparative Example 3.

It was confirmed from the measurement results of these Examples and Comparative Examples that the charge-discharge cycle characteristics of a lithium secondary battery can be greatly improved by, in a negative electrode having a plurality of active material members on the surface of a current collector, forming a conductor so as to be in contact with each active material member. It was also found that the aforementioned effects are obtained irrespective of the oxygen ratio of the active material members, the type of electrically conductive material contained in the conductors, or the method of forming the conductors.

### INDUSTRIAL APPLICABILITY

A negative electrode according to the present invention is applicable to lithium secondary batteries in various forms, but will be particular advantageous when applied to a lithium secondary battery which is required to have high charge-discharge cycle characteristics. It is also useful as an electrode plate of an electrochemical capacitor of a type in which lithium ions move.

There is no particular limitation as to the shape of the lithium secondary battery to which the present invention is applicable, and any shape may be used, e.g., coin-type, button-type, sheet-type, cylindrical-type, flat-type, or prismatic-type. Moreover, the configuration of the electrode group consisting of a positive electrode, a negative electrode, and a separator may be a wound type or a stacked type. Furthermore, the battery size may be small, as used for small-sized portable devices or the like, or large, as used for electric vehicles or the like. For example, a lithium secondary battery according to the present invention can be used as a power supply of a mobile information terminal, a portable electronic device, a small-sized power storage device for households, a motorcycle, an electric vehicle, a hybrid electric vehicle, or the like. However, there is no particular limitation as to its usage.

1. A negative electrode for a lithium secondary battery comprising:
a current collector; and
a plurality of active material complexes disposed on the current collector and extending in a protruding direction from the current collector, wherein,
each active material complex includes
an active material member made of a substance which occludes and releases lithium and
a conductor disposed in contact with the active material member, the conductor being made of a substance which does not occlude or release lithium; and
from a surface or surface vicinity of the current collector, the conductor extends in a direction non-parallel to the surface of the current collector.

2. The negative electrode for a lithium secondary battery of claim 1, wherein the conductor is disposed in contact with a side face of the active material member.

3. The negative electrode for a lithium secondary battery of claim 2, wherein,
the active material member has a growth direction which is tilted with respect to a normal direction of the current collector; and
in a cross section which is perpendicular to the current collector and which contains a growth direction of the active material member, the conductor is formed in a portion of the side face of the active material member that is located on an upper side, and a portion of the side face of the active material member that is located on a lower side is not covered with the conductor.

4. The negative electrode for a lithium secondary battery of claim 1, wherein,
the active material member includes a plurality of active material portions stacked on the surface of the current collector; and
the conductor includes a plurality of conductive portions disposed respectively in contact with side faces of the plurality of active material portions.

5. The negative electrode for a lithium secondary battery of claim 4, wherein,
each of the plurality of active material portions has a growth direction which is tilted with respect to a normal direction of the current collector; and
in a cross section which is perpendicular to the current collector and which contains the growth directions of the plurality of active material portions, each of the plurality of conductive portions is formed in a portion of the side face of the corresponding active material portion that is located on an upper side, and a portion of the side face of the corresponding active material portion that is located on a lower side is not covered with the conductive portion.

6. The negative electrode for a lithium secondary battery of claim 4, wherein each the plurality of conductive portions is disposed in proximity with another adjoining conductive portion so that the conductive portions are equipotential.

7. The negative electrode for a lithium secondary battery of claim 4, wherein growth directions of the plurality of active material portions are alternately tilted in opposite directions with respect to a normal direction of the current collector.

8. The negative electrode for a lithium secondary battery of claim 7, wherein the conductor extends in a zigzag manner from the surface or surface vicinity of the current collector, in a direction away from the current collector.

9. The negative electrode for a lithium secondary battery of claim 1, wherein at least a part of the conductor is located in the interior of each active material complex.

10. The negative electrode for a lithium secondary battery of claim 9, wherein,
the active material member includes a plurality of active material portions stacked on the surface of the current collector; and
at least a part of the conductor is located at an interface between vertically-adjoining ones of the plurality of active material portions.

11. The negative electrode for a lithium secondary battery of claim 1, wherein,
the current collector includes a plurality of bumps on the surface; and
each active material complex is supported by one of the plurality of bumps.

12. The negative electrode for a lithium secondary battery of claim 1, wherein the conductors is a metal containing at least one element selected from the group consisting of Cu, Ni, Ti, Zr, Cr, Fe, Mo, Mn, Nb, and V.

13. The negative electrode for a lithium secondary battery of claim 1, wherein the conductor is an electrically conductive ceramic containing a nitride of Ti and/or a nitride of Zr.

14. The negative electrode for a lithium secondary battery of claim 1, wherein the plurality of active material regions contain an active material selected from the group consisting of silicon, tin, silicon oxide, tin oxide, and a mixture thereof.

15. A lithium-ion secondary battery comprising:
a positive electrode capable of occluding and releasing lithium ions;
the negative electrode for a lithium secondary battery claim 1;
a separator disposed between the positive electrode and the negative electrode for a lithium secondary battery; and
an electrolyte having lithium-ion conductivity.

16. A method of producing a negative electrode for a lithium secondary battery, including a step of forming a plurality of active material complexes on a current collector, comprising the steps of:
(A) supplying silicon onto a surface of a current collector from a first direction which is tilted with respect to a normal direction of the current collector, thereby forming on the surface of the current collector a plurality of active material portions which are disposed at an interval with one another; and
(B) from a second direction which is different from the first direction, supplying a gas containing an electrically conductive material onto the surface of the current collector having the plurality of active material portions formed thereon to form a conductive portion on each of the plurality of active material portions, thereby obtaining a plurality of active material complexes each having an active material portion and a conductive portion.

17. The method of producing a negative electrode for a lithium secondary battery of claim 16, wherein an angle α between the first direction and the normal direction of the current collector is no less than 20° and no more than 85°, and the angle β between the second direction and the normal direction of the current collector is smaller than the angle α.

18. The method of producing a negative electrode for a lithium secondary battery of claim 16, wherein the electrically conductive material is a metal containing at least one element selected from the group consisting of Cu, Ni, Ti, Zr, Cr, Fe, Mo, Mn, Nb, and V.

19. The method of producing a negative electrode for a lithium secondary battery of claim 16, wherein the electrically conductive material is a metal containing Ti and/or Zr.

20. The method of producing a negative electrode for a lithium secondary battery of claim 16, wherein the conductive portion comprises an electrically conductive ceramic containing a nitride of Ti and/or a nitride of Zr.

21. A negative electrode for a lithium secondary battery produced by the method of claim 16.
